(19) United States
(12) Patent Application Publication
(10) Pub. No.: US 2022/0084550 A1
(43) Pub. Date: Mar. 17, 2022

(54) MAGNETIC RECORDING TAPE AND MAGNETIC RECORDING TAPE CARTRIDGE

(71) Applicant: SONY GROUP CORPORATION, TOKYO (JP)

(72) Inventors: TOMOE OZAKI, TOKYO (JP); JUNICHI TACHIBANA, TOKYO (JP); TOMOE SATO, TOKYO (JP); RYOICHI HIRATSUKA, TOKYO (JP); HIROTO ATAGI, TOKYO (JP); KAZUYA HASHIMOTO, TOKYO (JP); YOICHI KANEMAKI, TOKYO (JP); YUUKO KAMOSHITA, TOKYO (JP); HIKARU TERUI, TOKYO (JP)

(21) Appl. No.: 17/421,409

(22) PCT Filed: Dec. 2, 2019
(86) PCT No.: PCT/JP2019/047100

§ 371 Date: Jul. 8, 2021

(30) Foreign Application Priority Data
Jan. 21, 2019 (JP) 2019-007574

(51) Int. Cl. G11B 5/851; G11B 5/706; G11B 5/85; G11B 5/735; G11B 5/714; G11B 5/78; G11B 5/008

(52) U.S. Cl. CPC G11B 5/851; G11B 5/70678; G11B 5/85; G11B 5/00817; G11B 5/714; G11B 5/78; G11B 5/7356

(57) ABSTRACT

An object is to suppress or prevent a dimensional change of a magnetic recording tape.

The present technology provides a magnetic recording tape having a layer structure including a magnetic layer, a base layer, and a back layer in this order, in which a reinforcing layer containing a metal or a metal oxide is disposed on either a surface of the base layer on the magnetic layer side or a surface of the base layer on the back layer side, and a black area in an image obtained by binarizing an optical microscope image of a rectangular region of 64 μm×48 μm of the reinforcing layer is 300 μm² or less. Furthermore, the present technology also provides a magnetic recording tape having a layer structure including a magnetic layer, a base layer, and a back layer in this order, in which a reinforcing layer containing a metal or a metal oxide is disposed on either a surface of the base layer on the magnetic layer side or a surface of the base layer on the back layer side, and the number of black regions in an image obtained by binarizing an optical microscope image of a rectangular region of 64 μm×48 μm of the reinforcing layer is 70 or less.

### TECHNICAL FIELD

The present technology relates to a magnetic recording tape and a magnetic recording tape cartridge. More specifically, the present technology relates to a magnetic recording tape suppressing deformation (dimension change) and a magnetic recording tape cartridge in which the magnetic recording tape is housed.

### BACKGROUND ART

In recent years, with spread of the Internet, cloud computing, and accumulation and analysis of big data, the amount of information to be recorded over a long period of time has increased explosively. Therefore, a recording medium used for backing up or archiving information as data is required to have a higher recording capacity. Among the recording media, a “magnetic recording tape” (hereinafter, also referred to as a “tape”) has been attracting attention again from various viewpoints such as cost, energy saving, long life, reliability, and capacity.

The magnetic recording tape is housed in a case while the long tape including a magnetic layer is wound around a reel. On the magnetic recording tape, recording or reproduction is performed in a direction in which the tape travels using a magnetic resistance type head (hereinafter, also referred to as a magnetic head). In 2000, an open standard linear tape-open (LTO) appeared, and since then, the generation has been updated.

The recording capacity of the magnetic recording tape depends on a surface area (tape length×tape width) of the magnetic recording tape and a recording density per unit area of the tape. The recording density depends on a track density in a tape width direction and a line recording density (recording density in a tape length direction). That is, an increase in the recording capacity of the magnetic recording tape depends on how the tape length and/or the recording density (more particularly, the track density and/or the line recording density) can be increased. Note that the tape width can be determined by a standard.

It is conceivable to thin the tape in order to increase the tape length. Regarding thinning of the tape, for example, Patent Document 1 below discloses “a magnetic recording medium including a polyester film having an SRa value of 2 to 20 nm on one surface A, an SRa value of 2 to 50 nm on the other surface B, a Young's modulus of 6000 MPa or more in a longitudinal direction, and a Young's modulus of 6000 MPa or more in a width direction, in which a non-magnetic metal layer or a metal oxide layer is disposed on at least the surface B, and a magnetic layer is disposed on the surface A side” (claim 1). The Patent Document 1 below describes that the magnetic recording medium can be thinned, that a digital recording signal can be reproduced favorably even after the magnetic recording medium is stored for a long time under high temperature and high humidity, and that the magnetic recording medium is preferable for digital recording by a helical scan method.

### CITATION LIST

### Patent Document

Patent Document 1: Japanese Patent Application Laid-Open No. 11-339250

### SUMMARY OF THE INVENTION

### Problems to be Solved by the Invention

It is required to further increase a recording capacity of the magnetic recording tape. For example, in order to increase the recording capacity (recording area), it is conceivable to make the magnetic recording tape thinner (reduce the total thickness of the tape) and to increase the tape length per tape cartridge product. However, due to thinning of the tape, deformation (elongation) in a track width direction (tape width direction) is likely to occur. The deformation can be caused by, for example, a change in environment such as tension applied to the tape during tape traveling or humidity and temperature. Deformation of the tape destabilizes traveling performance of the tape or causes spacing between a magnetic head and the tape, which can reduce recording/reproducing characteristics of the tape.

Furthermore, for example, when the track density is increased, an off-track phenomenon is more likely to occur when the magnetic recording tape travels at a high speed. The off-track phenomenon means that a target track does not exist at a track position to be read by a magnetic head, or the magnetic head reads a wrong track position. Deformation of the tape can make the off-track phenomenon more likely to occur.

Therefore, a main object of the present technology is to suppress or prevent a dimensional change of the magnetic recording tape.

### Solutions to Problems

The present technology provides a magnetic recording tape having a layer structure including a magnetic layer, a base layer, and a back layer in this order, in which a reinforcing layer containing a metal or a metal oxide is disposed on either a surface of the base layer on the magnetic layer side or a surface of the base layer on the back layer side, and a black area in an image obtained by binarizing an optical microscope image of a rectangular region of 64 μm×48 μm of the reinforcing layer is 300 μm² or less.

The reinforcing layer may have a thickness of 500 nm or less.

The reinforcing layer may have a Young's modulus of 70 GPa or more.

The Young's modulus of the reinforcing layer can be 10 times or more the Young's modulus of the base layer.

According to one embodiment of the present technology, the reinforcing layer may be a vapor-deposited film layer containing a metal or a metal oxide.

The vapor-deposited film layer can have a thickness of 350 nm or less.

According to another embodiment of the present technology, the reinforcing layer may be constituted by a vapor-deposited film layer containing a metal or a metal oxide and a metal sputter layer, and the metal sputter layer may be disposed between the base layer and the vapor-deposited film layer.

The metal sputter layer can have a thickness of 25 nm or less.

The vapor-deposited film layer can have a thickness of 10 nm to 200 nm.

The magnetic layer can have a track density of 10000 tracks/inch or more in a tape width direction.

The base layer can have a thickness of 3.6 μm or less.

The vapor-deposited film layer may be formed by an electron beam vapor deposition method.

The magnetic recording tape can have a total thickness of 5.6 μm or less.

The present technology also provides a magnetic recording tape cartridge including the magnetic recording tape, in which the magnetic recording tape is housed in a case while being wound around a reel.

Furthermore, the present technology also provides a magnetic recording tape having a layer structure including a magnetic layer, a base layer, and a back layer in this order, in which a reinforcing layer containing a metal or a metal oxide is disposed on either a surface of the base layer on the magnetic layer side or a surface of the base layer on the back layer side, and the number of black regions in an image obtained by binarizing an optical microscope image of a rectangular region of 64 μm×48 μm of the reinforcing layer is 70 or less.

### BRIEF DESCRIPTION OF DRAWINGS

FIG. 1 is a diagram illustrating an example of a layer structure of a magnetic recording tape according to the present technology.

FIG. 2 is a diagram illustrating an example of a layer structure of a magnetic recording tape according to the present technology.

FIG. 3 is a diagram for explaining the thickness of a base layer and the thickness of a reinforcing layer.

FIG. 4 is a diagram illustrating an example of a layer structure of a magnetic recording tape according to the present technology.

FIG. 5 is a diagram illustrating an example of a layer structure of a magnetic recording tape according to the present technology.

FIG. 6 is an example of a flow of a method for manufacturing a magnetic recording tape according to the present technology.

FIG. 7 is a diagram illustrating a configuration example of a tape cartridge according to the present technology.

FIG. 8 is a schematic diagram of an example of a vacuum film forming device for forming a reinforcing layer.

FIG. 9 is a diagram illustrating an example of a layer structure of a magnetic recording tape according to the present technology.

FIG. 10 is a diagram illustrating an example of a layer structure of a magnetic recording tape according to the present technology.

FIG. 11 is an example of a flow of a method for manufacturing a magnetic recording tape according to the present technology.

FIG. 12 is a graph illustrating a relationship between a Young's modulus and a black area.

FIG. 13 is a graph illustrating a relationship between a Young's modulus and the number of black regions.

FIG. 14 is a diagram illustrating an image after a reinforcing layer image is binarized.

FIG. 15 is a diagram illustrating an image after a reinforcing layer image is binarized.

### MODE FOR CARRYING OUT THE INVENTION

Hereinafter, a preferable embodiment for carrying out the present technology will be described. Note that the embodiments described below exemplify representative embodiments of the present technology, and the scope of the present technology is not limited only to the embodiments. For example, various modifications are possible within the scope of the technical idea of the present technology. For example, the configurations, the methods, the steps, the shapes, the materials, and the numerical values exemplified in the following embodiments are examples, and a configuration, a method, a step, a shape, a material, and a numerical value different therefrom may be used as necessary.

The present technology will be described in the following order.

1. First embodiment of the present technology (magnetic recording tape)

(1) Description of first embodiment

(2) Configuration example of a layer constituting a magnetic recording tape (magnetic recording tape in which a magnetic layer is formed by application)

(2-1) Magnetic layer

(2-2) Non-magnetic layer

(2-3) Base layer

(2-4) Reinforcing layer

(2-4-1) Reinforcing layer constituted by a vapor-deposited film layer

(2-4-2) Reinforcing layer constituted by a vapor-deposited film layer and a metal sputter layer

(2-5) Back layer

(3) An example of a method for manufacturing a magnetic recording tape according to the present technology (magnetic recording tape in which a magnetic layer is formed by application)

(3-1) Coating material preparing step

(3-2) Reinforcing layer forming step

(3-3) Application step

(3-4) Orientation step

(3-5) Calender step

(3-6) Shearing step

(3-7) Assembling step

(4) Configuration example of a layer constituting a magnetic recording tape (magnetic recording tape in which a magnetic layer is formed by sputtering)

(4-1) Lubricant layer

(4-2) Protective layer

(4-3) Magnetic layer

(4-4) Intermediate layer

(4-5) Ground layer

(4-6) Seed layer

(4-7) Base layer

(4-8) Reinforcing layer

(4-9) Back layer

(4-10) Soft magnetic underlayer

(5) Example of a method for manufacturing a magnetic recording tape according to the present technology (magnetic recording tape in which a magnetic layer is formed by sputtering)

(5-1) Reinforcing layer forming step

(5-2) Sputter film forming step

(5-3) Application step

(5-4) Shearing step

(5-5) Assembling step

2. Second embodiment of the present technology (magnetic recording tape cartridge)

### 1. First Embodiment of the Present Technology (Magnetic Recording Tape)

### (1) Description of First Embodiment

In order to improve transversal dimensional stability of a magnetic recording tape, it is conceivable to dispose a reinforcing layer containing a metal material (for example, a metal or a metal oxide). The present inventors have discovered a reinforcing layer that brings about a particularly excellent effect of improving transversal dimensional stability from among the reinforcing layers. By observing reinforcing layers of a plurality of magnetic recording tapes in order to identify a factor that brings about the particularly excellent effect of improving transversal dimensional stability, the present inventors have found that the area of voids existing in each of the reinforcing layers is related to the effect of improving transversal dimensional stability. As a result of further examination, the present inventors have found that a fact that the black area in an image obtained by binarizing an optical microscope image of a rectangular region of 64 μm×48 μm of the reinforcing layer is 300 μm² or less brings about the particularly excellent effect of improving transversal dimensional stability.

That is, the present technology provides a magnetic recording tape having a layer structure including a magnetic layer, a base layer, and a back layer in this order, in which a reinforcing layer containing a metal or a metal oxide is disposed on either a surface of the base layer on the magnetic layer side or a surface of the base layer on the back layer side, and a black area in an image obtained by binarizing an optical microscope image of a rectangular region of 64 μm×48 μm of the reinforcing layer is 300 μm² or less.

Furthermore, the present inventors have also found that the number of voids contained in the reinforcing layer is related to the effect of improving transversal dimensional stability. Moreover, the present inventors have found that a fact that the number of black regions in an image obtained by binarizing an optical microscope image of a rectangular region of 64 μm×48 μm of the reinforcing layer is 100 or less contributes to the particularly excellent effect of improving transversal dimensional stability.

That is, the present technology also provides a magnetic recording tape having a layer structure including a magnetic layer, a base layer, and a back layer in this order, in which a reinforcing layer containing a metal or a metal oxide is disposed on either a surface of the base layer on the magnetic layer side or a surface of the base layer on the back layer side, and the number of black regions in an image obtained by binarizing an optical microscope image of a rectangular region of 64 μm×48 μm of the reinforcing layer is 100 or less.

The magnetic recording tape according to the present technology includes a specific reinforcing layer as described above. The reinforcing layer can suppress or prevent occurrence of a dimensional change (particularly a dimensional change in a tape width direction). For example, the reinforcing layer can suppress or prevent a dimensional change due to a tension applied to the tape during tape traveling and/or a dimensional change due a change in environment such as temperature and/or humidity.

Furthermore, the specific reinforcing layer can suppress or prevent occurrence of a dimensional change of the tape, and can reduce the thickness of the tape. As a result, the length of the tape housed in one magnetic recording tape cartridge can be increased while recording/reproducing characteristics are maintaining and occurrence of an off-track phenomenon is suppressed. This brings about an increase in recording capacity per magnetic recording tape cartridge.

The magnetic recording tape according to the present technology may include another layer in addition to the magnetic layer, the base layer, the back layer, and the reinforcing layer. The another layer may be appropriately selected according to the type of the magnetic recording tape.

For example, a magnetic recording tape in which a magnetic layer is formed by application can include a non-magnetic layer between a magnetic layer and a base layer. That is, according to one embodiment of the present technology, the magnetic recording tape may include a magnetic layer, a non-magnetic layer, a base layer, and a back layer in this order, and the reinforcing layer may be disposed on either a surface of the base layer on the magnetic layer side or a surface of the base layer on the back layer side. That is, the magnetic recording tape can have a laminated structure in which a magnetic layer, a non-magnetic layer, a reinforcing layer, a base layer, and a back layer are laminated in this order, or a laminated structure in which a magnetic layer, a non-magnetic layer, a base layer, a reinforcing layer, and a back layer are laminated in this order. This embodiment will be described in more detail in (2) and (3) below.

Furthermore, a magnetic recording tape in which a magnetic layer is formed by sputtering can include a ground layer and a seed layer, or an intermediate layer, a ground layer, and a seed layer between the magnetic layer and a base layer. That is, according to another embodiment of the present technology, the magnetic recording tape may include a magnetic layer, a ground layer, a seed layer, a base layer, and a back layer in this order, and the reinforcing layer may be disposed on either a surface of the base layer on the magnetic layer side or a surface of the base layer on the back layer side. That is, the magnetic recording tape can have a laminated structure in which a magnetic layer, a ground layer, a seed layer, a reinforcing layer, a base layer, and a back layer are laminated in this order, or a laminated structure in which a magnetic layer, a ground layer, a seed layer, a base layer, a reinforcing layer, and a back layer are laminated in this order. This embodiment will be described in more detail in (4) and (5) below.

### (2) Configuration Example of a Layer Constituting a Magnetic Recording Tape (Magnetic Recording Tape in which a Magnetic Layer is Formed by Application)

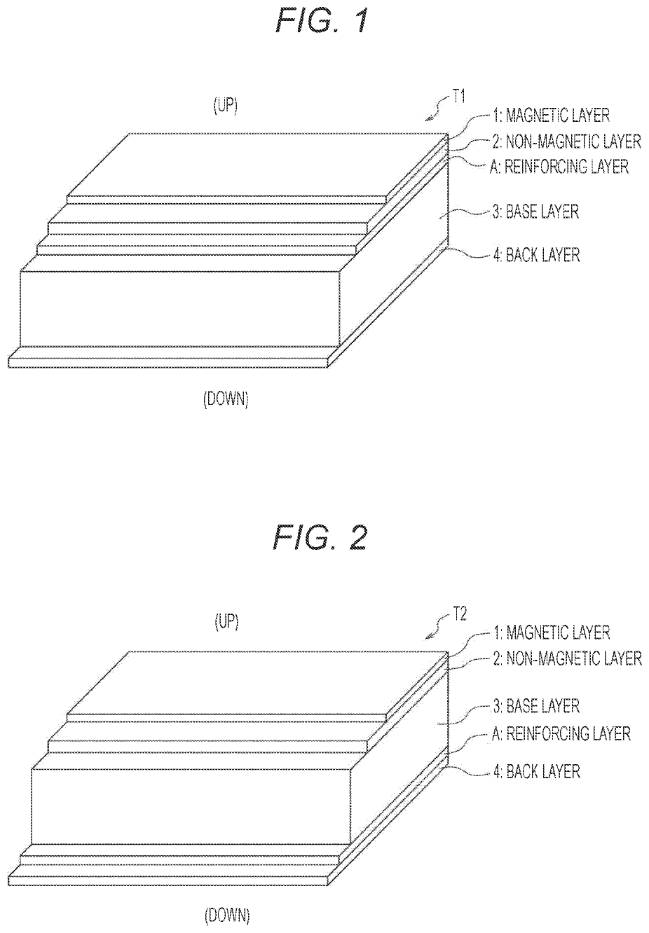

FIG. 1 is a diagram illustrating an example of a basic layer structure of the magnetic recording tape according to the present technology. A magnetic recording tape T1 (hereinafter, also referred to as “tape T1”) illustrated in FIG. 1 may travel at a high speed of, for example, 4 m/sec or more during recording or reproduction. That is, the magnetic recording tape T1 of the present technology may be used for recording or reproduction at a tape speed of 4 m/sec or more. In a case where such high-speed traveling is performed, a tension applied to the tape T1 is large.

The total thickness of the tape T1 may be preferably 5.6 μm or less, more preferably 5.0 μm or less, still more preferably 4.8μ or less, and particularly preferably 4.6 μm or less from a viewpoint that the present technology targets a magnetic recording tape having a high recording capacity. In addition, the tape T1 includes a magnetic layer 1, a non-magnetic layer 2, a reinforcing layer A, a base layer 3, and a back layer 4 in order from the top (from a side facing a magnetic head during recording or reproduction). That is, the non-magnetic layer 2 is disposed directly below the magnetic layer 1, the reinforcing layer A is disposed directly below the non-magnetic layer 2, the base layer 3 is disposed directly below the reinforcing layer A, and the back layer 4 is disposed directly below the base layer 3. The tape T1 has a layer structure including a total of five layers. Note that in addition to these five layers, another layer may be disposed as necessary. For example, a protective film layer and/or a lubricant layer may be further laminated on the magnetic layer 1. Furthermore, an intermediate layer may be disposed between the magnetic layer 1 and the base layer 3.

Each of the layers will be described in more detail below.

In the description of the present technology, the vertical direction of the layer structure will be described with the magnetic layer 1 side as “up” and the back layer 4 side as “down” as illustrated in FIG. 1.

Note that in the following description of the tape T1 (FIG. 1), a configuration common to a tape T2 also applies to the tape T2 (FIG. 2).

(2-1) Magnetic Layer

The magnetic layer 1 is located on a surface layer and functions as a signal recording layer. A preferable range for the thickness of the magnetic layer 1 is 20 nm to 100 nm. The lower limit value of the thickness, 20 nm, is a limit thickness at which the magnetic layer 1 can be applied uniformly and stably. It is not desirable that the thickness exceeds the upper limit value 100 nm from a viewpoint of setting a bit length of a high recording density tape.

The average thickness of the magnetic layer 1 can be determined as follows. First, the tape T1 is thinly processed perpendicularly to a main surface thereof to manufacture a sample piece. A cross section of the sample piece is observed with a transmission electron microscope (TEM). A device and observation conditions are as follows. Device: TEM (H9000NAR manufactured by Hitachi Ltd.), acceleration voltage: 300 kV, and magnification: 100,000 times.

Next, using the obtained TEM image, the thickness of the magnetic layer 1 is measured at at least 10 or more points in a longitudinal direction of the tape T1. Then, the measured values are simply averaged (arithmetically averaged) to determine an average thickness d of the magnetic layer 1. Note that the measurement points are randomly selected from the test piece.

The magnetic layer 1 preferably has a plurality of servo bands and a plurality of data bands in advance. The plurality of servo bands is disposed at regular intervals in a width direction of the tape T1. A data band is disposed between adjacent servo bands. In the servo band, a servo signal for performing tracking control of a magnetic head is written in advance. User data is recorded in the data band. The number of servo bands is preferably 5 or more, and more preferably 5+4n (in which n is a positive integer) or more. When the number of servo bands is 5 or more, an influence on a servo signal due to a dimensional change of the tape T1 in a width direction thereof can be suppressed, and stable recording/reproducing characteristics with less off-track can be ensured.

In the present technology, the track density of the magnetic layer 1 may be, for example, 10000 tracks/inch or more in the tape width direction. The magnetic recording tape having the track density has a high recording density.

The magnetic layer 1 contains at least magnetic powder (powder-like magnetic particles), and the magnetic powder is longitudinally oriented (in-plane oriented) or perpendicularly oriented. A signal can be recorded by changing magnetic properties of the magnetic layer 1 by magnetism. The recording may be performed using a known in-plane magnetic recording method (a method in which a magnetization direction is a longitudinal direction of a tape) or a known perpendicular magnetic recording method (a method in which the magnetization direction is a perpendicular direction).

The degree of perpendicular orientation of the magnetic layer 1 in the perpendicular direction of the tape is preferably 60% or more, and more preferably 65% or more. Furthermore, a ratio of the degree of perpendicular orientation of the magnetic layer 1 in the perpendicular direction of the tape to the degree of orientation of the magnetic layer 1 in the longitudinal orientation of the tape is, for example, 1.5 or more, preferably 1.8 or more, and more preferably 1.85 or more. A magnetic recording tape having a degree of perpendicular orientation within the numerical range and/or a ratio within the numerical range is more reliable.

The degree of perpendicular orientation of the magnetic layer 1 may be measured as follows.

First, a measurement sample is cut out from the tape T1, and an M-H loop of the entire measurement sample is measured using VSM in a perpendicular direction (thickness direction) of the tape T1. Next, the coating film (the non-magnetic layer 2, the magnetic layer 1, and the back layer 3) are wiped off with acetone, ethanol, and the like to obtain a background correction sample while only the base layer 3 and the vapor-deposited film layer A are left. An M-H loop of the background correction sample is measured using VSM in the perpendicular direction of the background correction sample (perpendicular direction of the tape). Thereafter, the M-H loop of the background correction sample is subtracted from the M-H loop of the entire measurement sample to obtain an M-H loop after background correction. The degree of perpendicular orientation S1 (%) is calculated by putting saturation magnetization Ms (emu) and residual magnetization Mr (emu) of the obtained M-H loop into the following formula 1. Note that each of the above measurements of the M-H loops is performed at 25° C. Furthermore, when the M-H loop is measured in a perpendicular direction of the tape, “demagnetizing field correction” is not performed.

Degree of perpendicular orientation S1(%)=(Mr/Ms)×100 Formula 1:

Furthermore, the degree of orientation in the longitudinal direction is measured in a similar manner to the degree of perpendicular orientation except that the M-H loop of the entire measurement sample and the M-H loop of the background correction sample are measured in the longitudinal direction (traveling direction) of the tape.

In the in-plane magnetic recording method, for example, magnetic recording is performed on the magnetic layer 1 containing metallic magnetic powder in the longitudinal direction of the tape. In the perpendicular magnetic recording method, for example, magnetic recording is performed on the magnetic layer 1 containing magnetic powder such as barium ferrite (BaFe) magnetic powder in the perpendicular direction of the tape T1. Note that in the perpendicular magnetic recording method, adjacent magnetic materials strengthen each other's magnetism, and the recording density can be further increased as compared with the in-plane magnetic recording method. Furthermore, a magnetic layer on which magnetic recording has been performed by the perpendicular magnetic recording method has a high coercive force (Hc), the coercive force (Hc) being a force for holding magnetic force. In either method, a signal is recorded by magnetizing a magnetic particle in the magnetic layer 1 by applying a magnetic field from a magnetic head.

Examples of the magnetic particle forming the magnetic powder in the magnetic layer 1 include epsilon-type iron oxide (s iron oxide), gamma hematite, magnetite, chromium dioxide, cobalt-coated iron oxide, hexagonal ferrite, barium ferrite (BaFe), Co ferrite, strontium ferrite, and metal, but are not limited thereto. Note that ε iron oxide may contain Ga and/or Al. These magnetic particles may be appropriately selected by those skilled in the art on the basis of factors such as a method for manufacturing the magnetic layer 1, the standard of the tape, and the function of the tape.

The shape of the magnetic particle depends on the crystal structure of the magnetic particle. For example, the BaFe can be hexagonal plate-shaped. The ε iron oxide can be spherical. The cobalt ferrite can be cubic. The metal can be spindle-shaped. In the magnetic layer 1, these magnetic particles are oriented in a step of manufacturing the tape T1. Note that the BaFe has high data recording reliability. For example, the BaFe keeps a coercive force even in a high-temperature and high-humidity environment. Therefore, the BaFe can be one of preferable magnetic materials in the present technology. That is, in the present technology, the magnetic particle contained in the magnetic layer 1 can be preferably a BaFe particle.

The magnetic powder may be, for example, powder of nanoparticles containing ε iron oxide (hereinafter referred to as “ε iron oxide particles”). The ε iron oxide particle has a high coercive force even if the ε iron oxide particle is a fine particle. ε iron oxide contained in the ε iron oxide particle is preferably crystal-oriented preferentially in a thickness direction (perpendicular direction) of the tape T1.

The ε iron oxide particle will be described in more detail. The ε iron oxide particle can be spherical or substantially spherical, or can be cubic or substantially cubic. Since the εiron oxide particle has the above shape, in a case where the ε iron oxide particle is used as the magnetic particle, a contact area between particles in a thickness direction of the tape T1 can be reduced, and aggregation of the particles can be suppressed as compared with a case where a hexagonal plate-shaped barium ferrite particle is used as the magnetic particle. As a result, dispersibility of the magnetic powder can be enhanced, and a better signal-to-noise ratio (SNR) can be obtained.

The ε iron oxide particle can have a core-shell type structure. Specifically, the ε iron oxide particle may have a core portion and a two-layer shell portion disposed around the core portion. The two-layer shell portion has a first shell portion disposed on the core portion and a second shell portion disposed on the first shell portion. The core portion contains ε iron oxide. ε iron oxide contained in the core portion preferably contains an ε-Fe₂O₃ crystal as a main phase, and more preferably contains ε-Fe₂O₃ as a single phase.

The first shell portion covers at least a part of a periphery of the core portion. Specifically, the first shell portion may partially cover the periphery of the core portion or may cover the entire periphery of the core portion. In order to improve magnetic characteristics by making exchange coupling between the core portion and the first shell portion sufficient, the first shell portion preferably covers the entire surface of the core portion.

The first shell portion is a so-called soft magnetic layer, and can contain, for example, a soft magnetic material such as α-Fe, a Ni—Fe alloy, or a Fe—Si—Al alloy. α-Fe may be obtained by reducing ε iron oxide contained in the core portion.

The second shell portion may be an oxide film that functions as an antioxidant layer. The second shell portion can contain α iron oxide, aluminum oxide, silicon oxide, or a combination of two or more of these. α iron oxide contains, for example, at least one iron oxide selected from Fe₃O₄, Fe₂O₃, and FeO. In a case where the first shell portion contains α-Fe (soft magnetic material), a iron oxide may be obtained by oxidizing α-Fe contained in the first shell portion.

By inclusion of the first shell portion in the ε iron oxide particle as described above, a coercive force Hc of the entire ε iron oxide particles (core-shell particles) can be prepared to a coercive force Hc suitable for recording while a coercive force Hc of the core portion alone is maintained at a large value in order to ensure thermal stability.

Furthermore, by inclusion of the second shell portion in the ε iron oxide particle as described above, it is possible to suppress deterioration of the characteristics of the ε iron oxide particle due to generation of a rust and the like on a surface of the particle by exposure of the ε iron oxide particle to the air during a step of manufacturing the tape T1 and before the step. Therefore, characteristic deterioration of the tape T1 can be suppressed.

Hereinabove, the case where the ε iron oxide particle has a two-layer shell portion has been described. However, the ε iron oxide particle may have a single layer shell portion. In this case, the shell portion has a similar configuration to the first shell portion. However, as described above, the ε iron oxide particle more preferably has a two-layer shell portion in order to suppress characteristic deterioration of the ε iron oxide particle.

The ε iron oxide particle may contain an additive instead of the core-shell structure, or may contain an additive while having the core-shell structure. In a case where the ε iron oxide particle contains the additive, a part of Fe of the ε iron oxide particle is replaced with the additive. Even by inclusion of the additive in the ε iron oxide particle, a coercive force Hc of the entire ε iron oxide particles can be adjusted to a coercive force Hc suitable for recording. Therefore, recordability can be improved. The additive may be, for example, a metal element other than iron, preferably a trivalent metal element, more preferably at least one selected from Al, Ga, and In, and still more preferably at least one selected from Al and Ga.

Specifically, the ε iron oxide containing the additive is an ε-Fe₂₋ₓMₓO₃ crystal (in which M represents a metal element other than iron, preferably a trivalent metal element, more preferably at least one selected from Al, Ga, and In, and still more preferably at least one selected from Al and Ga, and x satisfies, for example, 0<x<1).

The magnetic powder may be powder of nanoparticles containing hexagonal ferrite (hereinafter referred to as “hexagonal ferrite particles”). The hexagonal ferrite particle has, for example, a hexagonal plate shape or a substantially hexagonal plate shape. The hexagonal ferrite preferably contains at least one selected from Ba, Sr, Pb, and Ca, more preferably at least one selected from Ba and Sr.

Specifically, the hexagonal ferrite may be, for example, barium ferrite or strontium ferrite. The barium ferrite may further contain at least one selected from Sr, Pb, and Ca in addition to Ba. The strontium ferrite may further contain at least one selected from Ba, Pb, and Ca in addition to Sr.

More specifically, the hexagonal ferrite has an average composition represented by a general formula MFe₁₂O₁₉. Provided that M represents, for example, at least one metal selected from Ba, Sr, Pb, and Ca, preferably at least one metal selected from Ba and Sr. M may represent a combination of Ba and one or more metals selected from the group consisting of Sr, Pb, and Ca. Furthermore, M may represent a combination of Sr and one or more metals selected from the group consisting of Ba, Pb, and Ca. In the above general formula, some of Fe atoms may be replaced with other metal atoms.

In a case where the magnetic powder contains powder of hexagonal ferrite particles, the average particle size of the magnetic powder is preferably 50 nm or less, more preferably 10 nm or more and 40 nm or less, and still more preferably 15 nm or more and 30 nm or less.

As the magnetic powder, powder of nanoparticles containing Co-containing spinel ferrite (hereinafter referred to as “cobalt ferrite particles”) may be used. The cobalt ferrite particle preferably has uniaxial anisotropy. The cobalt ferrite particle has, for example, a cubic shape or a substantially cubic shape. The Co-containing spinel ferrite may further contain at least one selected from Ni, Mn, Al, Cu, and Zn in addition to Co.

The Co-containing spinel ferrite has, for example, an average composition represented by the following formula (1).

CoₓM_{y}Fe₂O_{z} (1)

(Provided that in formula (1), M represents, for example, at least one metal selected from Ni, Mn, Al, Cu, and Zn). x represents a value within a range of 0.4≤x≤1.0. y represents a value within a range of 0≤y≤0.3. Provided that x and y satisfy a relationship of (x+y)≤1.0. z represents a value within a range of 3≤z≤4. Some of Fe atoms may be replaced with other metal atoms.) In a case where the magnetic powder contains powder of cobalt ferrite particles, the average particle size of the magnetic powder is preferably 25 nm or less, and more preferably 23 nm or less.

The average particle size D of the magnetic powder can be determined as follows. First, the tape T1 to be measured is processed by a focused ion beam (FIB) method or the like to manufacture a thin piece, and a cross section of the thin piece is observed with TEM. Next, 500 particles of the magnetic powder are randomly selected from the imaged TEM photograph, the maximum particle size dₘₐₓ of each of the particles is measured, and a particle size distribution of the maximum particle size dₘₐₓ of the magnetic powder is determined. Here, the “maximum particle size dₘₐₓ” means a so-called maximum Feret diameter, and specifically means the largest distance among distances between two parallel lines drawn from all angles so as to come into contact with an outline of each of the particles of the magnetic powder. Thereafter, a median diameter (50% diameter, D50) of the maximum particle size dₘₐₓ is determined from the determined particle size distribution of the maximum particle size dₘₐₓ to be used as the average particle size (average maximum particle size) D of the magnetic powder.

The magnetic powder has an average aspect ratio of preferably 1 or more and 2.5 or less, more preferably 1 or more and 2.1 or less, still more preferably 1 or more and 1.8 or less. When the average aspect ratio of the magnetic powder is within a range of 1 or more and 2.5 or less, aggregation of the magnetic powder can be suppressed, and resistance applied to the magnetic powder can be suppressed when the magnetic powder is perpendicularly oriented in a step of forming the magnetic layer 1. That is, perpendicular orientation of the magnetic powder can be improved.

The average aspect ratio of the magnetic powder can be determined as follows. First, the tape T1 to be measured is processed by an FIB method or the like to manufacture a thin piece, and a cross section of the thin piece is observed with TEM. Next, 50 particles of the magnetic powder oriented at an angle of 75 degrees or more with respect to a horizontal direction are randomly selected from the imaged TEM photograph, and a maximum plate thickness DA of each of the particles of the magnetic powder is measured. Subsequently, the maximum plate thicknesses DA of the measured 50 particles of the magnetic powder are simply averaged (arithmetically averaged) to determine an average maximum plate thickness DAave. Next, a surface of the magnetic layer 1 of the tape T1 is observed by TEM. Next, 50 particles of the magnetic powder are randomly selected from the imaged TEM photograph, and a maximum plate diameter DB of each of the particles of the magnetic powder is measured. Here, the maximum plate diameter DB means the largest distance among distances between two parallel lines drawn from all angles so as to come into contact with an outline of each of the particles of the magnetic powder (so-called maximum Feret diameter). Subsequently, the maximum plate diameters DB of the measured 50 particles of the magnetic powder are simply averaged (arithmetically averaged) to determine an average maximum plate diameter DBave. Next, an average aspect ratio (DBave/DAave) of the magnetic powder is determined from the average maximum plate thickness DAave and the average maximum plate diameter DBave.

Furthermore, in addition to the magnetic powder, the magnetic layer 1 may contain, for example, a non-magnetic additive in order to increase the strength and/or durability of the magnetic layer 1. The magnetic layer 1 may contain, for example, a binder and/or a lubricant as the additive. The magnetic layer 1 may further contain one or a combination of two or more selected from a dispersant, conductive particles, an abrasive, and a rust preventive as the additive as necessary. The magnetic layer 1 may have a large number of holes (not illustrated) for storing a lubricant. The large number of holes preferably extend in a direction perpendicular to a surface of the magnetic layer 1.

The magnetic layer 1 may be formed by applying a magnetic coating material containing magnetic powder and, as necessary, an additive to a layer below the magnetic layer 1. Alternatively, the magnetic layer 1 may be formed by a sputtering method or a vapor deposition method.

Examples of the binder to be blended in the magnetic layer 1 include a resin such as a polyurethane-based resin or a vinyl chloride-based resin, and the binder is preferably a resin having a cross-linking reactive structure. The binder is not limited to these resins, and another resin may be contained as the binder in the magnetic layer 1, for example, according to physical properties and the like required for the tape T1. The resin contained in the magnetic layer 1 may be a resin generally used in a magnetic recording tape.

Examples of the resin used as the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylate-acrylonitrile copolymer, an acrylate-vinyl chloride-vinylidene chloride copolymer, a vinyl chloride-acrylonitrile copolymer, an acrylate-acrylonitrile copolymer, an acrylate-vinylidene chloride copolymer, a methacrylate-vinylidene chloride copolymer, a methacrylate-vinyl chloride copolymer, a methacrylate-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, and nitrocellulose), a styrene-butadiene copolymer, a polyester resin, an amino resin, and a synthetic rubber. Furthermore, the binder may be a thermosetting resin or a reactive resin. Examples of the thermosetting resin or the reactive resin include a phenol resin, an epoxy resin, a urea resin, a melamine resin, an alkyd resin, a silicone resin, a polyamine resin, and a urea formaldehyde resin.

In order to improve dispersibility of the magnetic powder, a polar functional group such as —SO₃M, —OSO₃M, —COOM, or P═O(OM)₂ may be introduced into each of the above-described binders. Here, in the formulas, M represents a hydrogen atom or an alkali metal such as lithium, potassium, or sodium. Moreover, examples of the polar functional group include a side chain type group having a terminal group of —NR1R2 or —NR1R2R3+X—, and a main chain type group of >NR1R2+X—. Here, R1, R2, and R3 in the formulas each independently represent a hydrogen atom or a hydrocarbon group, and X— represents an ion of a halogen element such as fluorine, chlorine, bromine, or iodine, or an inorganic or organic ion. Furthermore, examples of the polar functional group include —OH, —SH, —CN, and an epoxy group.

As non-magnetic reinforcing particles, the magnetic layer 1 may further contain one or a combination of two or more selected from aluminum oxide (α, β, or γ alumina), chromium oxide, silicon oxide, diamond, garnet, emery, boron nitride, titanium carbide, silicon carbide, titanium carbide, and titanium oxide (rutile type or anatase type titanium oxide).

The lubricant of the magnetic layer 1 preferably contains a compound represented by the following general formula (2) and/or a compound represented by the following general formula (3). By inclusion of these compounds in the lubricant, a coefficient of dynamic friction on a surface of the magnetic layer 1 can be particularly reduced. Therefore, traveling performance of the tape T can be further improved.

CH₃(CH₂)ₙCOOH (2)

(Provided that in general formula (2), n is an integer selected from a range of 14 or more and 22 or less.)

CH₃(CH₂)ₚCOO(CH₂)_{q}CH₃ (3)

(Provided that in general formula (3), p is an integer selected from a range of 14 or more and 22 or less, and q is an integer selected from a range of 2 or more and 5 or less.)

The coefficient of dynamic friction of the tape T1 is an important factor in relation to stable traveling of the tape T1. A ratio (μ_{B}/μ_{A}) between a coefficient of dynamic friction μ_{A} between a surface of the magnetic layer 1 and a magnetic head H when a tension applied to the tape T1 is 1.2 N, and a coefficient of dynamic friction μ_{B} between the surface of the magnetic layer 1 and the magnetic head H when the tension applied to the tape T1 is 0.4 N is preferably 1.0 or more and 2.0 or less. The ratio within this numerical range can reduce a change in the coefficient of dynamic friction due to a tension fluctuation during traveling, and therefore can stabilize traveling of the tape.

Regarding the coefficient of dynamic friction μ_{A} between the surface of the magnetic layer 1 and the magnetic head when the tension applied to the tape T1 is 0.6, a ratio (μ1000/μ5) between a value μ5 at the fifth travel and a value μ1000 at the 1000th travel is preferably 1.0 or more and 2.0 or less, and more preferably 1.0 or more and 1.7 or less. The ratio within the above numerical range can reduce a change in the coefficient of dynamic friction due to multiple traveling, and therefore can stabilize traveling of the tape.

(2-2) Non-Magnetic Layer

The non-magnetic layer 2 disposed directly below the magnetic layer 1 (that is, in contact with the magnetic layer 1) is also sometimes referred to as an intermediate layer or a ground layer. The non-magnetic layer 2 is disposed, for example, in order to retain an action of a magnetic force to the magnetic layer 1 on the magnetic layer 1, to ensure flatness required for the magnetic layer 1, or to enhance the orientation characteristics of the magnetic layer 1. Furthermore, the non-magnetic layer 2 can also play a role of holding a lubricant added to the magnetic layer 1 and/or a lubricant added to the non-magnetic layer 2 itself.

The non-magnetic layer 2 can be formed on the “base layer 3” described below, for example, by application. The non-magnetic layer 2 may have a multilayer structure depending on a purpose and necessity. It is important to use a non-magnetic material for this non-magnetic layer 2. This is because magnetization of a layer other than the magnetic layer 1 generates noise.

The non-magnetic layer 2 is a non-magnetic layer containing non-magnetic powder and a binder. The non-magnetic layer 2 may further contain at least one additive selected from a binder, a lubricant, conductive particles, a curing agent, a rust preventive, and the like as necessary. The binder used for the non-magnetic layer 2 is similar to that used for the magnetic layer 1 described above.

The non-magnetic powder can contain, for example, at least one selected from inorganic particles and organic particles. One kind of non-magnetic powder may be used singly, or two or more kinds of non-magnetic powder may be used in combination. The inorganic particles include, for example, one or a combination of two or more selected from a metal, a metal oxide, a metal carbonate, a metal sulfate, a metal nitride, a metal carbide, and a metal sulfide. More specifically, the inorganic particles can be one or more selected from, for example, iron oxyhydroxide, hematite, titanium oxide, and carbon black. Examples of the shape of the non-magnetic powder include various shapes such as an acicular shape, a spherical shape, a cubic shape, and a plate shape, but are not limited thereto.

The average thickness of the non-magnetic layer 2 is preferably 0.8 μm or more and 2.0 μm or less, and more preferably 0.6 μm or more and 1.4 μm or less. The average thickness of the non-magnetic layer 2 is determined in a similar manner to the average thickness of the magnetic layer 1. However, a magnification of a TEM image is appropriately prepared according to the thickness of the non-magnetic layer 2. When the average thickness of the magnetic layer 2 is less than 0.6 μm, a function of retaining an additive (for example, lubricant) blended in the magnetic layer 1 or the non-magnetic layer 2 itself is lost. Meanwhile, when the average thickness of the magnetic layer 2 exceeds 2.0 μm, the total thickness of the tape T1 is too thick, which goes against the trend of thinning the tape T1 and pursuing a high recording capacity.

(2-3) Base Layer

Next, the base layer 3 illustrated in FIG. 1 mainly functions as a base layer of the tape T1. The base layer 3 may also be referred to as a base film layer, a substrate, or a non-magnetic support. The base layer 3 mainly functions as a non-magnetic support that supports layers such as the non-magnetic layer 2 and the magnetic layer 1, and imparts rigidity to the entire tape T1. The base layer 3 is in a form of a long flexible film.

The average thickness of the base layer 3 is, for example, less than 4.5 μm, preferably 4.2 μm or less, more preferably 3.6 μm or less, and still more preferably 3.3 μm or less. According to one embodiment of the present technology, the average thickness of the base layer 3 is 3.6 μm or less. As the base layer 3 is thinner, the total thickness of the tape is also thinner, and therefore the recording capacity that can be recorded in one cartridge product can be increased as compared with a general magnetic recording medium. Note that a lower limit of the thickness of the base layer 3 may be determined, for example, from a viewpoint of a limit on film formation or the function of the base layer 3.

The average thickness of the base layer 3 can be determined as follows. First, the tape T1 having a width of ½ inches is prepared and cut into a length of 250 mm to manufacture a sample. Subsequently, the layers other than the base layer 3 of the sample are removed with a solvent such as methyl ethyl ketone (MEK) or dilute hydrochloric acid. Next, the thickness of the sample (base layer 3) is measured at five or more points using a laser hologage manufactured by Mitsutoyo Corporation as a measuring device, and the measured values are simply averaged (arithmetically averaged) to calculate the average thickness of the base layer 3. Note that the measurement points are randomly selected from the sample.

The base layer 3 may contain at least one selected from a polyester, a polyolefin, a cellulose derivative, a vinyl-based resin, and another polymer resin. In a case where the base layer 3 contains two or more selected from the above materials, the two or more materials may be mixed, copolymerized, or laminated. The polyester contains, for example, at least one selected from polyethylene terephthalate (PET), polyethylene naphthalate (PEN), polybutylene terephthalate (PBT), polybutylene naphthalate (PBN), polycyclohexylenedimethylene terephthalate (PCT), polyethylene-p-oxybenzoate (PEB), and polyethylene bisphenoxycarboxylate. The polyolefin contains, for example, at least one selected from polyethylene (PE) and polypropylene (PP). The cellulose derivative contains, for example, at least one selected from cellulose diacetate, cellulose triacetate, cellulose acetate butyrate (CAB), and cellulose acetate propionate (CAP). The vinyl-based resin contains, for example, at least one selected from polyvinyl chloride (PVC) and polyvinylidene chloride (PVDC). The other polymer resin contains, for example, at least one selected from polyamide or nylon (PA), aromatic polyamide or aramid (aromatic PA), polyimide (PI), aromatic polyimide (aromatic PI), polyamide imide (PAI), aromatic polyamide imide (aromatic PAI), polybenzoxazole (PBO) such as ZYLON (registered trademark), polyether, polyether ketone (PEK), polyether ester, polyether sulfone (PES), polyether imide (PEI), polysulfone (PSF), polyphenylene sulfide (PPS), polycarbonate (PC), polyarylate (PAR), and polyurethane (PU). The base layer 3 preferably contains a polyester-based resin, and may contain, for example, PEN, PET, or PBT.

The material of the base layer 3 is not particularly narrowly limited, but may be determined by the standard of the magnetic recording tape. For example, the LTO standard specifies PEN as the material of base layer 3.

(2-4) Reinforcing Layer

The reinforcing layer A illustrated in FIG. 1 is disposed on a surface of the base layer 3 on the magnetic layer 1 side, and contains a metal or a metal oxide. That is, the reinforcing layer A is in contact with either one of the two surfaces of the base layer 3.

According to one preferable embodiment of the present technology, the tape T1 has a configuration in which a black area in an image obtained by binarizing an optical microscope image of a rectangular region of 64 μm×48 μm of the reinforcing layer A is 300 μm² or less. The configuration brings about a particularly excellent effect of improving transversal dimensional stability. The black area can be more preferably 280 μm² or less, still more preferably 260 μm² or less, and further still more preferably 240 μm² or less. The black area is preferably smaller, and the black area can be, for example, 0 μm² or more.

According to another preferable embodiment of the present technology, the tape T1 can have a configuration in which the number of black regions in an image obtained by binarizing an optical microscope image of a rectangular region of 64 μm×48 μm of the reinforcing layer A is 100 or less. The number of black regions can be more preferably 80 or less, still more preferably 60 or less, and further still more preferably 50 or less. The number of black regions is preferably smaller, and the number of black regions can be, for example, 0 or more.

According to a particularly preferable embodiment of the present technology, the tape T1 can have a configuration in which a black area in an image obtained by binarizing an optical microscope image of a rectangular region of 64 μm×48 μm of the reinforcing layer A is 300 μm² or less, and the number of black regions in the image is 100 or less.

An outline of a method for measuring the black area and the number of black regions is as follows. That is, first, an optical microscope image of a rectangular region of 64 μm×48 μm of the reinforcing layer A is acquired (step of acquiring an optical microscope image). Next, the acquired optical microscope image is binarized to obtain an image, and a black area and the number of black regions is measured from the obtained image (step of measuring a black area or the number of black regions by binarization). The details of the measurement method will be described below.

(Step of Acquiring an Optical Microscope Image)

The magnetic layer 1 and the non-magnetic layer 2 of the magnetic recording tape T1 to be measured are peeled off using a non-woven fabric wiper impregnated with an organic solvent (for example, Bemcot (trademark)). As a result, the reinforcing layer A is exposed. As illustrated in FIG. 1, in a case where the reinforcing layer A is disposed on a surface of the base layer 3 on the magnetic layer A side, the tape with the reinforcing layer A exposed is attached to a slide glass with the exposed reinforcing layer A facing up (that is, attached to the slide glass such that the bottom layer (back layer 4) is in contact with a surface of the slide glass). As illustrated in FIG. 2, in a case where the reinforcing layer A is disposed on a surface of the base layer 3 on the back layer 4 side, the back layer 4 is also peeled off using an organic solvent in a similar manner to the above, and the tape is attached to a slide glass with the surface from which the back layer 4 has been peeled off facing up (that is, attached to the slide glass such that a surface of the base layer 3 on the magnetic layer 1 side is in contact with a surface of the slide glass). The reinforcing layer A of the tape attached to the slide glass is observed using the following device as an optical microscope under the following observation conditions. The observation is performed by disposing the reinforcing layer A among the layers constituting the tape so as to be closest to an objective lens. In the observation, five points are randomly selected from the tape, “MX80-DUV” software attached to the following device is started, Control Panel window is opened, a file is stored, and the images at the five points are thereby acquired as an image file.

Device: Olympus MX80-DUV deep ultraviolet microscope

Objective lens: 10×

Size of magnetic recording tape: 12.5 mm×50 mm

Observation range on one screen: 64×48 μm

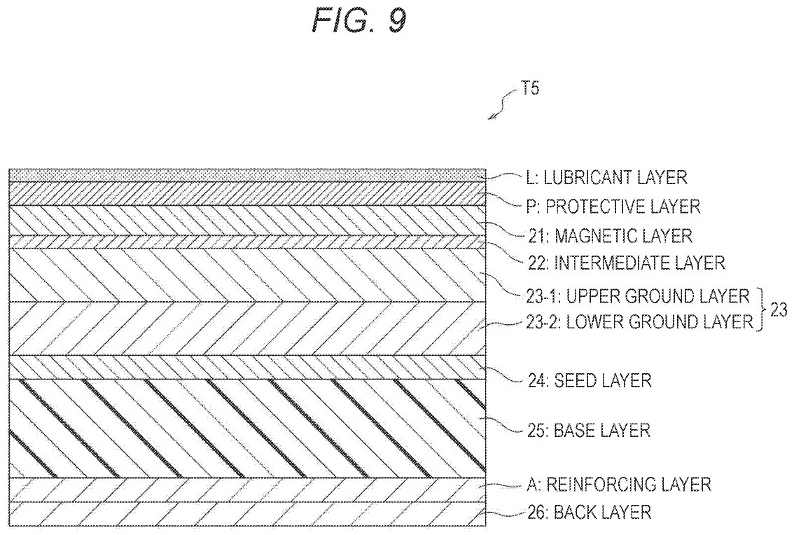

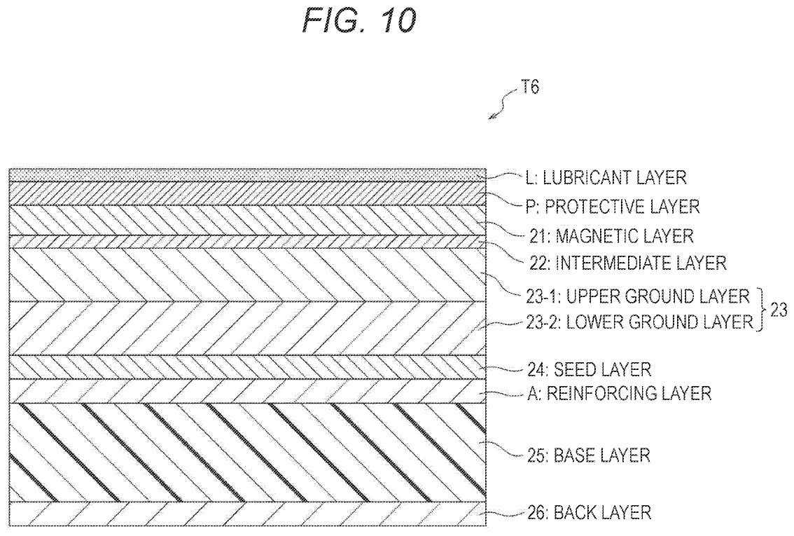

Note that in a case of a sputter type magnetic recording tape described in the following “(4) Configuration example of a layer constituting a magnetic recording tape (magnetic recording tape in which a magnetic layer is formed by sputtering)”, a lubricant layers L to a seed layer 24 are not peeled off, a back layer 26 is peeled off using an organic solvent in a similar manner to the above, and then the tape is attached to a slide glass with the surface from which the back layer 26 has been peeled off facing up. Then, as described above, a surface of the reinforcing layer A is observed (for example, in a case of the tape illustrated in FIG. 9, the reinforcing layer A is observed so as to be closest to an objective lens, and in a case of the tape illustrated in FIG. 10, the reinforcing layer A is observed through the base layer 25).

(Step of Measuring a Black Area or the Number of Black Regions by Binarization).

The image file of the images at the five points acquired in the acquisition step is processed as follows using image analysis software ImageJ (available from the National Institutes of Health). In this process, an image processing range is set to 64×48 μm. A specific operation procedure of the software is described in parentheses for each of the following steps.

Step 1: Open an image file. (File-Open)

Step 2: Enter dimensions. (Analyze-Set Scale)

The dimensions are set as follows.

Distance in pixels: 640

Known distance: 64

Pixel aspect ratio: 1.0

Unit of length: um

Step 3: Convert an image type to an 8-bit grayscale image. (Image (image menu)>Type (image type)>8 bit)

Step 4: Remove noise. (Prosess (process menu)>Smooth (smoothing))

Step 5: Perform binarization. (Process (process menu)>Binary (binarization)>Make Binary (form an image into white and black))

Step 6: Perform analysis. (Analyze (analysis menu)→Analyze Particles (particle analysis))

In the analysis, a threshold is set as follows.

Size (Pixel\hat{ }2): 100-10000

Circularity: 0.00-1.00

Show: Masks

By checking Summarize after setting the threshold, a Summary screen is displayed. On the Summary screen, Count (number of particles), Total Area (sum of areas), Average size (number of particles), Area Function (ratio of area occupied by particles), and Mean (average) are displayed.

Step 7: For the images at the five points acquired in the acquisition step, the above steps 1 to 6 are performed, and an average value (simple average) of the obtained Total Area (sum of areas) or an average value (simple average) of the obtained Count (number of particles) is calculated. These average values are the “black area in an image obtained by binarizing an optical microscope image of a rectangular region of 64 μm×48 μm of the reinforcing layer A” and the “number of black regions in an image obtained by binarizing an optical microscope image of a rectangular region of 64 μm×48 μm of the reinforcing layer A” in the present technology, respectively.

By disposing the reinforcing layer A in the tape T1, the rigidity of the thinly formed tape T1 can be increased. In order to increase a recording capacity of the tape per roll of a tape cartridge product, it is conceivable to reduce the track width of the magnetic layer 1 to increase the track density, and to reduce the thickness of the tape T1 to increase the tape length per roll of the tape cartridge product. In a case where the thickness of the tape T1 is reduced, a dimensional change of the tape is likely to occur due to an influence of a tension applied to the tape T1 during tape traveling or a change in environmental conditions during storage or transportation. In particular, a dimensional change or deformation in the tape width direction is likely to cause a phenomenon in which a magnetic field from a magnetic head deviates from a track during recording or reproduction, that is, a so-called “off-track phenomenon”. The reinforcing layer A plays a role of suppressing a dimensional change or deformation of the tape T1, preventing occurrence of the off-track phenomenon, and preventing a decrease in SNR (signal-to-noise ratio).

Furthermore, by inclusion of the reinforcing layer A in the tape T1, a dimensional change or deformation in the tape width direction can be suppressed in a case where a tensile tension is applied when the tape T1 travels at a high speed of 4 m/sec or more, which can prevent occurrence of the off-track phenomenon. Furthermore, by inclusion of the reinforcing layer A in the tape T1, even in a case where the tape T1 has a configuration in which the number of tracks in the tape width direction is 10000 tracks/inch or more, a dimensional change or deformation in the tape width direction can be suppressed, and occurrence of the off-track phenomenon can be prevented.

As illustrated in FIG. 1, the reinforcing layer A may be disposed on a surface of the base layer 3 on the magnetic layer 1 side. Alternatively, as illustrated in FIG. 2, the reinforcing layer A may be disposed on a surface of the base layer 3 on the back layer 4 side. By laminating the reinforcing layer A on either surface or both surfaces of the base layer 3, the tape T1 is reinforced.

The Young's modulus of the reinforcing layer A is preferably 70 GPa or more, more preferably 75 GPa or more, and still more preferably 80 GPa or more. In a case where the reinforcing layer A has a Young's modulus equal to or higher than the above lower limit value, the strength and transversal dimensional stability of the tape T1 are further enhanced. The Young's modulus is a Young's modulus of the magnetic recording tape T1 in a longitudinal direction. A method for calculating the Young's modulus is as follows.

First, the magnetic layer 1, the non-magnetic layer 2, and the back layer 4 of the magnetic recording tape T1 are removed with an organic solvent to obtain a laminate including only the base layer 3 and the reinforcing layer A. Note that in a case where the magnetic recording tape T1 contains another layer, the another layer is also removed. The Young's modulus of the laminate in the tape longitudinal direction is measured. The measurement is performed using a tensile tester (TCM-200CR manufactured by MinebeaMitsumi Inc.) in an environment of a temperature of 23° C. and a relative humidity of 60%. Using the measured Young's modulus of the laminate, the measured Young's modulus of the base layer 3, and the thicknesses of the laminate, the base layer 3, and the reinforcing layer, the Young's modulus of the reinforcing layer A is calculated by the following formula 2. Note that the Young's modulus of the base layer 3 may be determined in advance on the basis of a material of the base layer 3 used. For example, in a case where a commercially available material (for example, PEN or PET) is used as the base layer 3, the Young's modulus of the commercially available material is often known, and the known Young's modulus may be used.

E_{M}=(E_{(M+B)}×t_{(M+B)}−E_{B}×t_{B})/t_{M} Formula 2:

(Here, E_{M}: Young's modulus of reinforcing layer A, t_{M}: thickness of reinforcing layer A, E_{B}: Young's modulus of base layer 3, t_{B}: thickness of base layer 3, E_{(M+B)}: Young's modulus of (base layer 3+reinforcing layer A), t_{(M+B)}: thickness of (base layer+vapor-deposited film layer))

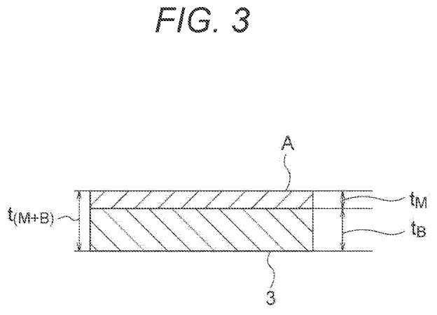

The above formula 2 is on the basis of an assumption that the reinforcing layer A and the base layer 3 are springs, and that the laminate is a parallel spring constituted by these two springs. That is, a relationship represented by the following formula 3 is satisfied between these two springs and the parallel spring. The thickness t_{M} of the reinforcing layer A, the thickness t_{B} of the base layer 3, and the thickness t_{(M+B)} of the (base layer 3+reinforcing layer A) in the following formula 3 are illustrated in FIG. 3. The following formula 3 is transformed into the above formula 2.

E_{(M+B)}×t_{(M+B)}=E_{B}×t_{B}+E_{M}×t_{M} Formula 3:

The Young's modulus of the reinforcing layer A can be preferably 10 times or more, more preferably 11 times or more, and still more preferably 12 times or more the Young's modulus of the base layer 3 from a viewpoint of reinforcing the base layer 3.

By inclusion of the reinforcing layer A, the magnetic recording tape T1 is less likely to cause a dimensional change due to temperature, humidity, or tension, that is, improves transversal dimensional stability (TDS) of the magnetic recording tape T1. As an index of transversal dimensional stability, for example, a total TDS (ppm) obtained by summing up TDS (temperature and humidity) and TDS (tension) may be used. Note that TDS (temperature and humidity) means transversal dimensional stability (TDS) with respect to changes in temperature and humidity. TDS (tension) means transversal dimensional stability (TDS) with respect to a tension.

The magnetic recording tape according to the present technology has a total TDS value of preferably 350 ppm or less, more preferably 340 ppm or less. A magnetic recording tape having such a total TDS value has excellent transversal dimensional stability. Note that a specific method for determining the total TDS will be described in Examples described later.

There is a correlation between Young's modulus and TDS (for example, total TDS). For example, the higher the Young's modulus, the lower the TDS. The magnetic recording tape according to the present technology has a higher Young's modulus due to the reinforcing layer A as described above, and therefore has a lower TDS.

The thickness of the reinforcing layer A can be preferably 600 nm or less, more preferably 500 nm or less, still more preferably 400 nm or less, and particularly preferably 350 nm or less. In a case where the thickness of the reinforcing layer A exceeds the above upper limit value, it may be difficult to thin the tape T1. Furthermore, in a case where the thickness of the reinforcing layer A exceeds the above upper limit value, productivity in forming the reinforcing layer A may deteriorate.

The reinforcing layer A may be as thin as possible as long as the reinforcing layer A brings about a desired rigidity. The thickness of the reinforcing layer A is, for example, 50 nm or more, preferably 70 nm or more, more preferably 100 nm or more, and still more preferably 120 nm or more.

(2-4-1) Reinforcing Layer Constituted by a Vapor-Deposited Film Layer

According to one preferable embodiment of the present technology, the reinforcing layer may be a vapor-deposited film layer containing a metal or a metal oxide. That is, the reinforcing layer may be a layer constituted only by a vapor-deposited film layer containing a metal or a metal oxide. For example, the reinforcing layer A illustrated in FIGS. 1 and 2 can be the vapor-deposited film layer.

The vapor-deposited film layer containing a metal or a metal oxide can provide a reinforcing layer having a black area and/or the number of black regions within the numerical range described above.

The vapor-deposited film layer contains a metal or a metal oxide. Examples of the metal or metal oxide include cobalt (Co), cobalt oxide (CoO), aluminum (Al), aluminum oxide (Al₂O₃), copper (Cu), copper oxide (CuO), chromium (Cr), silicon (Si), silicon dioxide (SiO₂), titanium (Ti), titanium oxide (TiO₂), nickel titanium (TiNi), cobalt chromium (CoCr), tungsten (W), and manganese (Mn). The vapor-deposited film layer may contain one or a combination of two or more selected from these metal materials. In the present technology, the vapor-deposited film layer may contain preferably one or a combination of two or more selected from the group consisting of Co, Al₂O₃, Si, Cu, and Cr, more preferably Co in order to exhibit the effect of the reinforcing layer A more effectively.

The reinforcing layer A constituted by the vapor-deposited film layer can be formed by evaporating and depositing the metal or metal oxide on the base layer 3. As a vapor deposition method, for example, an induction heating vapor deposition method, a resistance heating vapor deposition method, or an electron beam vapor deposition method may be adopted. Among these vapor deposition methods, the electron beam vapor deposition method is particularly preferable. By the electron beam vapor deposition method, it is possible to evaporate a metal or a metal oxide having a high melting point, the metal or metal oxide being difficult to evaporate. By using a material having a higher melting point, a more rigid vapor-deposited film layer can be formed. Furthermore, in the vapor deposition by the electron beam vapor deposition method, an output of an electron beam can be changed instantaneously, and heating can be started and ended instantly. These make more precise film thickness control possible. Moreover, the electron beam vapor deposition method is excellent in productivity because of efficient film formation.

In a case where the reinforcing layer A is constituted only by the vapor-deposited film layer containing a metal or a metal oxide, the thickness of the vapor-deposited film layer can be preferably 350 nm or less, and more preferably 345 nm or less. In a case where the reinforcing layer A has a thickness exceeding the upper limit value, a value of the black area may be large, and this may hinder improvement of transversal dimensional stability by the reinforcing layer A.

Furthermore, in a case where the reinforcing layer A is constituted only by the vapor-deposited film layer containing a metal or a metal oxide, the thickness of the vapor-deposited film layer may be as thin as possible as long as the vapor-deposited film layer brings about a desired rigidity. The reinforcing layer A has a thickness of, for example, 200 nm or more, preferably 210 nm or more.

(2-4-2) Reinforcing Layer Constituted by a Vapor-Deposited Film Layer and a Metal Sputter Layer

According to another preferable embodiment of the present technology, the reinforcing layer may be constituted by a vapor-deposited film layer containing a metal or a metal oxide and a metal sputter layer, and the metal sputter layer may be disposed between the base layer and the vapor-deposited film layer.

A reinforcing layer constituted by the vapor-deposited film layer and the metal sputter layer can also provide a reinforcing layer having a black area and/or the number of black regions within the numerical range described above. By disposing the metal sputter layer, the thickness of the vapor-deposited film layer can be further reduced, and this also contributes to reducing the thickness of the reinforcing layer and reducing the total thickness of the magnetic recording tape.

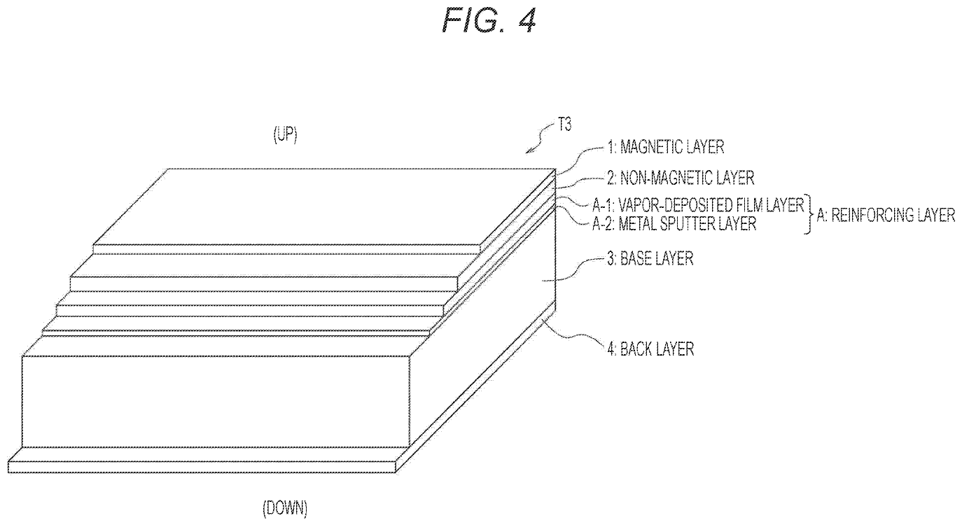

An example of the structure of the magnetic recording tape according to this embodiment is illustrated in FIG. 4. As illustrated in FIG. 4, a magnetic recording tape T3 has a magnetic layer 1, a non-magnetic layer 2, a reinforcing layer A, a base layer 3, and a back layer 4 laminated in this order. The reinforcing layer A is disposed between the non-magnetic layer 2 and the base layer 3, and is constituted by a vapor-deposited film layer A-1 and a metal sputter layer A-2. That is, the metal sputter layer A-2 is disposed between the vapor-deposited film layer A-1 and the base layer 3.

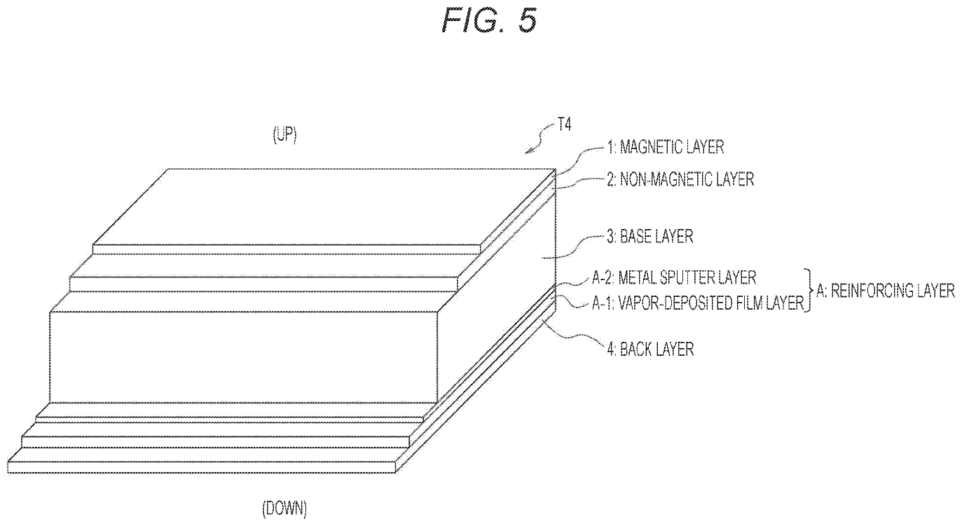

Alternatively, the layer structure as illustrated in FIG. 5 may be adopted. That is, a magnetic recording tape T4 has the magnetic layer 1, the non-magnetic layer 2, the base layer 3, the reinforcing layer A, and the back layer 4 laminated in this order. The reinforcing layer A is disposed between the base layer 3 and the back layer 4, and is constituted by the metal sputter layer A-2 and the vapor-deposited film layer A-1. Also in FIG. 5, the metal sputter layer A-2 is disposed between the vapor-deposited film layer A-1 and the base layer 3.

By disposing the metal sputter layer A-2 between the base layer 3 and the vapor-deposited film layer A-1, the thickness of the reinforcing layer A can be reduced, and the area and/or number of voids that can be generated in the reinforcing layer A can be reduced.

The vapor-deposited film layer A-1 contains a metal or a metal oxide. As a material of the vapor-deposited film layer A-1, one or a combination of two or more selected from the metal materials described in the above “(2-4-1)” may be used. In the present technology, the vapor-deposited film layer A-1 may contain preferably one or a combination of two or more selected from the group consisting of Co, Al₂O₃, Si, Cu, and Cr, more preferably Co in order to exhibit the effect of the reinforcing layer A more effectively.

The vapor-deposited film layer A-1 can be formed by any of the methods described for the vapor-deposited film layer in the above “(2-4-1)”. Among these vapor deposition methods, the electron beam vapor deposition method is particularly preferable.

The thickness of the vapor-deposited film layer A-1 can be preferably 10 nm to 200 nm, more preferably 50 nm to 190 nm, and still more preferably 100 nm to 180 nm. In the present embodiment, by disposing the metal sputter layer, the thickness of the vapor-deposited film layer can be reduced to these values.

The metal sputter layer A-2 contains a metal material. The metal material can be preferably Ti or a Ti alloy. Examples of the Ti alloy include TiCr. The Ti or Ti alloy is suitable for smoothing the metal sputter layer. The smoothness of the metal sputter layer makes it easier to reduce the area and/or number of voids in the reinforcing layer.

The metal sputter layer A-2 can be formed by a sputtering method. As an example of the sputtering method, for example, a magnetron type or ion beam type sputtering method may be adopted, but the sputtering method is not limited thereto. In the present technology, for example, a direct current (DC) magnetron type sputtering method may be adopted in order to form the metal sputter layer A-2.

The thickness of the metal sputter layer A-2 can be preferably 25 nm or less, more preferably 23 nm or less, and still more preferably 20 nm or less. The thickness of the metal sputter layer A-2 may be thicker, but is preferably the above upper limit value or less from a viewpoint of an effect of reducing the black area or the number of black regions by the metal sputter layer A-2 and cost for a process of forming the metal sputter layer A-2. Furthermore, in a case where the thickness is too large, the total thickness of the magnetic recording tape can be large.

The thickness of the metal sputter layer A-2 may be as thin as possible as long as the metal sputter layer A-2 brings about an effect of reinforcing the magnetic recording tape. The thickness of the metal sputter layer A-2 is, for example, 1 nm or more, and more preferably 2 nm or more. By having a thickness equal to or larger than the above lower limit value, the metal sputter layer A-2 can exhibit the reinforcing effect more effectively.

(2-5) Back Layer

The back layer 4 illustrated in FIG. 1 plays, for example, a role of controlling friction generated when the tape T1 travels at a high speed in a recording/reproducing device or a role of preventing winding disorder. That is, the back layer 4 plays a role of causing the tape T1 to travel stably at a high speed.

The back layer 4 may contain a binder and non-magnetic powder. The back layer 4 may further contain at least one additive selected from a lubricant, a curing agent, an antistatic agent as necessary. As for the binder and the non-magnetic powder, those described for the non-magnetic layer 2 described above also apply to the back layer 4. Furthermore, by inclusion of the antistatic agent in the back layer 4, it is possible to prevent dirt or dust from adhering to the back layer 4.

The non-magnetic powder that can be contained in the back layer 4 has an average particle size of preferably 10 nm or more and 150 nm or less, more preferably 15 nm or more and 110 nm or less. The average particle size of the non-magnetic powder is determined in a similar manner to the above average particle size of the magnetic powder. The non-magnetic powder may contain non-magnetic powder having two or more particle size distributions.

The back layer 4 preferably has an average thickness of 0.6 μm or less. When the average thickness of the back layer 4 is 0.6 μm or less, traveling stability of the tape T1 in the recording/reproducing device can be maintained even in a case where the average thickness of the tape T1 is small (for example, in a case where the average thickness is 5.6 μm or less). The lower limit value of the average thickness of the back layer 4 is not particularly limited, but may be, for example, 0.2 μm or more. When the average thickness of the back layer 4 is less than 0.2 μm, traveling stability of the tape T1 in the recording/reproducing device may be hindered.

The average thickness of the back layer 4 is determined as follows.

First, the tape T having a width of ½ inches is prepared and cut into a length of 250 mm to manufacture a sample. Next, the thickness of the sample is measured at five or more points using a laser hologage manufactured by Mitsutoyo Corporation as a measuring device, and the measured values are simply averaged (arithmetically averaged) to calculate an average value t_{T} [μm] of the tape T1. Note that the measurement points are randomly selected from the sample.

Subsequently, the back layer 4 of the sample is removed with a solvent such as methyl ethyl ketone (MEK) or dilute hydrochloric acid. Thereafter, the thickness of the sample is measured at five or more points using the above laser hologage, and the measured values are simply averaged (arithmetically averaged) to calculate an average value t_{B} [μm] of the tape T from which the back layer 4 has been removed. Note that the measurement points are randomly selected from the sample.

Thereafter, an average thickness t_{b} (μm) of the back layer 4 is determined by the following formula 4.

t_{b}[μm]=t_{T}[μm]−t_{B}[μm] Formula 4:

### (3) An Example of a Method for Manufacturing a Magnetic Recording Tape According to the Present Technology (Magnetic Recording Tape in which a Magnetic Layer is Formed by Application)

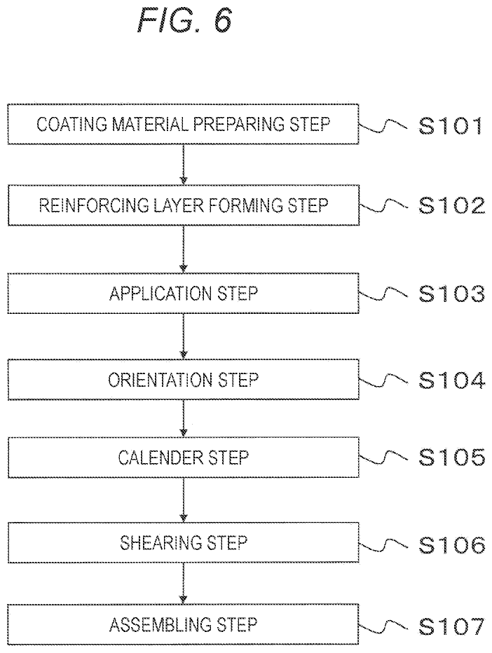

An example of a method for manufacturing a magnetic recording tape according to the present technology will be described with reference to FIG. 6. FIG. 6 illustrates a flow of a method for manufacturing the tape T1 described in the above “(2) Configuration example of a layer constituting a magnetic recording tape”.

An outline of the manufacturing method is as follows. First, a coating material for forming each of the magnetic layer 1, the non-magnetic layer 2, and the back layer 4 formed by being applied onto a substrate forming the base layer 3 is prepared (step S101: coating material preparing step). Next, the reinforcing layer A is formed on the base layer 3 to obtain a laminate including the base layer 3 and the reinforcing layer A (step S102: reinforcing layer forming step).

The coating materials for forming the three layers are applied so as to form the layer structure of the tape T1 (step S103: application step). For example, a non-magnetic layer forming coating material is applied to an exposed surface out of the two surfaces of the reinforcing layer A (that is, a surface not in contact with the base layer out of the two surfaces of the reinforcing layer A) and dried to form the non-magnetic layer 2. Subsequently, a magnetic layer forming coating material is applied to the non-magnetic layer 2 and dried, and the magnetic powder is oriented to form the magnetic layer 1. When the orientation of the magnetic layer 1 is completed, a back layer forming coating material is applied to a surface on which the vapor-deposited film layer A is not laminated out of the two surfaces of the base layer 3 and dried to form the back layer 4. In this way, the tape T1 including a total of five layers is manufactured.

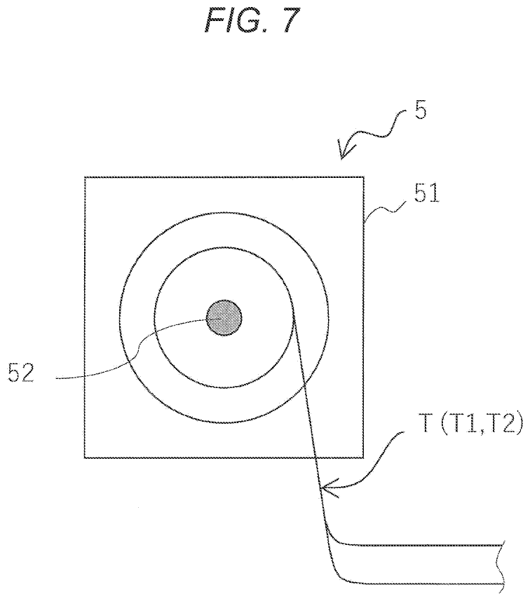

Subsequently, a calender step, a curing step, a shearing step, a cutting step, and an assembling step are performed to manufacture a tape cartridge product (see FIG. 7). The tape cartridge product can be shipped after being inspected.

The tape T2 described in the above “(2) Configuration example of a layer constituting a magnetic recording tape” may be manufactured by the same method as the manufacturing method described above for the tape T1 except that the application step is performed as follows.

In the application step in the method for manufacturing the tape T2, the coating materials for forming the three layers are applied so as to form the layer structure of the tape T2. For example, a non-magnetic layer forming coating material is applied to a surface on which the vapor-deposited film layer A is not laminated out of the two surfaces of the base layer 3 and dried to form the non-magnetic layer 2. Subsequently, a magnetic layer forming coating material is applied to the non-magnetic layer 2 and dried, and the magnetic powder is oriented to form the magnetic layer 1. After the orientation of the magnetic layer 1 is completed, a back layer forming coating material is applied to an exposed surface out of the two surfaces of the reinforcing layer A (that is, a surface not in contact with the base layer out of the two surfaces of the reinforcing layer A) and dried to form the back layer 4. In this way, the tape T2 including a total of five layers is manufactured.

Each of the steps in the flow illustrated in FIG. 6 will be described in more detail below. Furthermore, an example of the composition of each of the layer forming coating materials will also be described below.

(3-1) Coating Material Preparing Step

In step S101, the “non-magnetic layer forming coating material” is prepared by kneading and/or dispersing non-magnetic powder, a binder, and a lubricant in a solvent. Furthermore, the “magnetic layer forming coating material” is prepared by kneading and/or dispersing magnetic powder, a binder, and a lubricant in a solvent. Furthermore, the “back layer forming coating material” is prepared by kneading and/or dispersing a binder and non-magnetic powder in a solvent.

Examples of the solvent used for preparing the above-described magnetic layer forming coating material, non-magnetic layer forming coating material, and back layer forming coating material are described below. Furthermore, these coating materials may each contain another additive described in the above “(2) Configuration example of a layer constituting a magnetic recording tape” as necessary.

Examples of the solvent used for preparing the coating materials include: a ketone-based solvent such as acetone, methyl ethyl ketone, methyl isobutyl ketone, or cyclohexanone; an alcohol-based solvent such as methanol, ethanol, or propanol; an ester-based solvent such as methyl acetate, ethyl acetate, butyl acetate, propyl acetate, ethyl lactate, or ethylene glycol acetate; an ether-based solvent such as diethylene glycol dimethyl ether, 2-ethoxyethanol, tetrahydrofuran, or dioxane; an aromatic hydrocarbon-based solvent such as benzene, toluene, or xylene; and a halogenated hydrocarbon-based solvent such as methylene chloride, ethylene chloride, carbon tetrachloride, chloroform, or chlorobenzene, but are not limited thereto. The solvent used for preparing the coating materials may be any one of these compounds, or may be a mixture of two or more of these compounds.

Examples of a kneading device used for preparing the above-described coating materials include a kneading device such as a continuous twin-screw kneading machine, a continuous twin-screw kneading machine capable of performing dilution in multiple stages, a kneader, a pressure kneader, or a roll kneader, but are not limited to thereto. Furthermore, examples of a dispersing device used for preparing the above-described coating materials include a dispersing device such as a roll mill, a ball mill, a horizontal sand mill, a vertical sand mill, a spike mill, a pin mill, a tower mill, a pearl mill (for example, “DCP mill” manufactured by Eirich Co., Ltd.), a homogenizer, or an ultrasonic wave dispersing machine, but are not limited to these devices.

<Step of Preparing a Magnetic Layer Forming Coating Material>

The “magnetic layer forming coating material” can be prepared, for example, as follows. First, a first composition having the following composition is kneaded with an extruder. Next, the kneaded first composition and a second composition having the following composition are added to a stirring tank equipped with a disper, and are premixed. Subsequently, the mixture is further subjected to sand mill mixing, and is subjected to a filter treatment to prepare the magnetic layer forming coating material.

(First Composition)
Powder of barium ferrite (BaFe₁₂O₁₉) particles (hexagonal plate shape, aspect ratio 2.8, particle volume 1950 nm³): 100 parts by mass
Vinyl chloride-based resin (cyclohexanone solution 30% by mass): 10 parts by mass (degree of polymerization: 300, Mn=10000, OSO₃K=0.07 mmol/g and secondary OH=0.3 mmol/g are included as polar groups.)
Aluminum oxide powder: 5 parts by mass (α-Al₂O₃, average particle diameter: 0.2 μm)
Carbon black: 2 parts by mass (manufactured by Tokai Carbon Co., Ltd., trade name: Seast TA)

(Second Composition)
Vinyl chloride-based resin: 1.1 parts by mass (Resin solution: resin content 30% by mass, cyclohexanone 70% by mass)
n-Butyl stearate: 2 parts by mass
Methyl ethyl ketone: 121.3 parts by mass
Toluene: 121.3 parts by mass
Cyclohexanone: 60.7 parts by mass

Finally, 4 parts by mass of polyisocyanate (trade name: Coronate L, manufactured by Nippon Polyurethane Industry Co., Ltd.) as a curing agent and 2 parts by mass of myristic acid are added to the magnetic layer forming coating material prepared as described above.

<Step of preparing a non-magnetic layer forming coating material>

The “non-magnetic layer forming coating material” can be prepared, for example, as follows. First, a third composition having the following composition is kneaded with an extruder. Next, the kneaded third composition and a fourth composition having the following formulation are added to a stirring tank equipped with a disper, and are premixed. Subsequently, the mixture is further subjected to sand mill mixing, and is subjected to a filter treatment to prepare the non-magnetic layer forming coating material forming coating material.

(Third Composition)
Acicular iron oxide powder: 100 parts by mass (α-Fe₂O₃, average long axis length 0.15 μm)
Vinyl chloride-based resin: 55.6 parts by mass (Resin solution: resin content 30% by mass, cyclohexanone 70% by mass)
Carbon black: 10 parts by mass

(Average particle diameter 20 nm)

(Fourth Composition)
Polyurethane-based resin UR8200 (manufactured by Toyobo Co., Ltd.): 18.5 parts by mass
n-Butyl stearate: 2 parts by mass
Methyl ethyl ketone: 108.2 parts by mass
Toluene: 108.2 parts by mass
Cyclohexanone: 18.5 parts by mass

Finally, 4 parts by mass of polyisocyanate (trade name: Coronate L, manufactured by Nippon Polyurethane Industry Co., Ltd.) as a curing agent and 2 parts by mass of myristic acid are added to the non-magnetic layer forming coating material prepared as described above.

<Step of Preparing a Back Layer Forming Coating Material>

The back layer forming coating material can be prepared, for example, as follows. The following raw materials are mixed in a stirring tank equipped with a disper, and are subjected to filter treatment to prepare the back layer forming coating material.
Powder of carbon black particles (average particle diameter 20 nm): 90 parts by mass
Powder of carbon black particles (average particle diameter 270 nm): 10 parts by mass
Polyester polyurethane: 100 parts by mass
(manufactured by Nippon Polyurethane Industry Co., Ltd., trade name: N-2304)
Methyl ethyl ketone: 500 parts by mass
Toluene: 400 parts by mass
Cyclohexanone: 100 parts by mass

Note that the amount of the powder of carbon black particles (average particle diameter 20 nm) may be 80 parts by mass, and the amount of the powder of carbon black particles (average particle diameter 270 nm) may be 20 parts by mass.

As described above, each of the coating materials of the layers formed by application is prepared in the coating material preparing step.

(3-2) Reinforcing Layer Forming Step

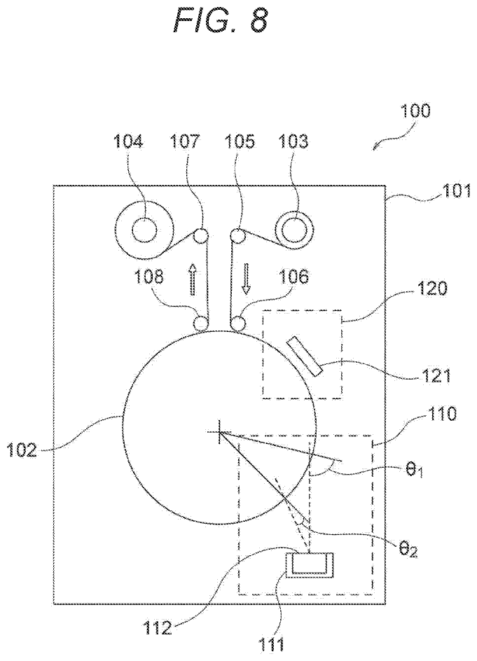

In the reinforcing layer forming step of step S102, the reinforcing layer is formed on the base layer. The reinforcing layer can be formed on the base layer, for example, using a roll-to-roll type vacuum film forming device. An example of the vacuum film forming device will be described below with reference to FIG. 8. FIG. 8 is a diagram illustrating an outline of the configuration of a vacuum film forming device 100. The vacuum film forming device 100 includes a cooling can 102 that rotates while being cooled in a vacuum chamber 101. The inside of the vacuum chamber 101 is maintained in a vacuum state by disposal from an exhaust port (not illustrated). A supply roll 103 and a winding roll 104 are disposed in the vacuum chamber 101. The substrate forming the base layer 3 is sequentially sent out from the supply roll 103, passes through a peripheral surface of the cooling can 102, and is then wound around the winding roll 104.

Guide rolls 105 and 106 are disposed between the supply roll 103 and the cooling can 102, and guide rolls 107 and 108 are disposed between the cooling can 102 and the winding roll 104. By these guide rolls, a predetermined tension is applied to the base layer 3 traveling from the supply roll 103 to the cooling can 102 and the base layer 3 traveling from the cooling can 102 to the winding roll 104, and the base layer 3 travels smoothly.

The vacuum chamber 101 includes a vapor-deposited film layer forming area 110 and a metal sputter layer forming area 120.

In a case where the tapes T1 and T2 described above are manufactured, a metal sputter layer is not formed in the metal sputter layer forming area 120, but a vapor-deposited film layer is formed in the vapor-deposited film layer forming area 110. As a result, a reinforcing layer constituted only by the vapor-deposited film layer is formed.

Furthermore, in a case where the tapes T3 and T4 described above are manufactured, a metal sputter layer is formed in the metal sputter layer forming area 120, and then, after the metal sputter layer is formed, a vapor-deposited film layer is formed on the metal sputter layer in the vapor-deposited film layer forming area 110. As a result, a reinforcing layer constituted by the vapor-deposited film layer and the metal sputter layer is formed.

A crucible 111 is disposed in the vapor-deposited film layer forming area 110. The crucible 111 is filled with a metal material (metal or metal oxide) 112 to form a vapor-deposited film layer. By irradiating the metal material 112 in the crucible 111 with an electron beam from an electron gun (not illustrated), the metal material is heated and evaporated from the metal material 112, and a vapor-deposited film layer is formed on the base layer 3 traveling on a peripheral surface of the cooling can 102.

The metal sputter layer forming area 120 includes a target 121. The target 121 can be a target containing only a metal to form a metal sputter layer. The target 121 may be supported, for example, by a backing plate (not illustrated) constituting a cathode electrode (not illustrated). Ar gas is introduced into the metal sputter layer forming area 120, and a voltage is applied using the cooling can 102 as an anode and the backing plate as a cathode. By applying the voltage, the Ar gas is turned into plasma. Then, an ionized ion collides with the target 121. The collision causes the metal to be ejected from the target 121. The ejected metal adheres to the base layer 3 traveling along a peripheral surface of the cooling can 102 to form a metal sputter layer.

(3-3) Application Step

In step S103, the non-magnetic layer forming coating material is applied to a surface not in contact with the base layer 3 out of the two surfaces of the reinforcing layer A (that is, an exposed surface) and dried to form the non-magnetic layer 2, for example, having an average thickness of 1.0 μm to 1.1 μm. Subsequently, the magnetic layer forming coating material is applied onto the non-magnetic layer 2 to form the magnetic layer 1, for example, having an average thickness of 40 nm to 100 nm. Then, after the magnetic layer 1 is formed by application, the magnetic layer 1 is subjected to an orientation treatment described in the following “(3-4) Orientation step”, and immediately after that, the magnetic layer 1 is dried. Then, the back layer forming coating material is applied to an exposed surface (that is, a surface not in contact with the reinforcing layer A) out of the two surfaces of the base layer 3 and dried to form the back layer 4. As a result, the tape T1 is formed.

Alternatively, the non-magnetic layer 2 and the magnetic layer 1 may be formed in a similar manner to the above directly above an exposed surface (that is, a surface not in contact with the reinforcing layer A) out of the two surfaces of the base layer 3. Then, the back layer 4 may be formed directly above a surface not in contact with the base layer 3 (that is, an exposed surface) out of the two surfaces of the reinforcing layer A. As a result, the tape T2 is formed.

(3-4) Orientation Step

In step S104, before the magnetic layer 1 formed by application is dried, for example, the magnetic powder in the magnetic layer 1 is magnetically oriented using a permanent magnet. For example, the magnetic powder in the magnetic layer 1 is magnetically oriented in a perpendicular direction (that is, a tape thickness direction) by a solenoid coil (perpendicular orientation). Furthermore, the magnetic powder may be magnetically oriented in a tape traveling direction (tape longitudinal direction) by the solenoid coil. Note that the magnetic layer 1 is preferably perpendicularly oriented from a viewpoint of increasing recording density, but may be in-plane oriented (longitudinally oriented) in some cases.

The degree of orientation (squareness ratio) can be adjusted by adjusting the strength of a magnetic field emitted from the solenoid coil (for example, 2 to 3 times the coercive force of the magnetic powder), by adjusting the solid content of the magnetic layer forming coating material, by adjusting drying conditions (drying temperature and drying time), or by a combination of these adjustments. Furthermore, the degree of orientation can also be adjusted by adjusting time for orienting the magnetic powder in a magnetic field. For example, in order to increase the degree of orientation, a dispersed state of the magnetic powder in the coating material is preferably improved. Furthermore, for perpendicular orientation, it is also effective to magnetize the magnetic powder in advance before the magnetic powder enters an orientation device, and this method may be used. By performing such an adjustment, the degree of orientation in a perpendicular direction (thickness direction of the magnetic tape) and/or a longitudinal direction (length direction of the magnetic tape) can be set to a desired value.

(3-5) Calender Step

In step S105, a calender treatment is performed to smooth a surface of the magnetic layer 1. This calender step is a mirror finishing step using a multi-stage roll device generally called a calender. While the tape T1 or T2 is sandwiched between opposing metal rolls, required temperature and pressure are applied to the tape T1 or T2 to smooth the surface of the magnetic layer 1.

(3-6) Shearing Step

In step S106, the wide magnetic recording tape T1 or T2 obtained as described above is sheared into, for example, a tape width conforming to the standard of the product type of the tape. For example, the magnetic recording tape T1 or T2 is sheared into a width of ½ inches (12.65 mm) and wound around a predetermined roll. As a result, the long magnetic recording tape T1 or T2 having a desired tape width can be obtained. In this shearing step, a necessary inspection may be performed.

(3-7) Assembling Step

In step S107, the magnetic recording tape T (T1 or T2) sheared into a predetermined width is cut into a predetermined length according to the product type to be formed into a form of a cartridge tape 5 as illustrated in FIG. 7. Specifically, the magnetic recording tape having a predetermined length is wound around a reel 52 disposed in a cartridge case 51 and housed therein.

After the assembling step, the cartridge tape 5 can be packed and shipped, for example, through a final product inspection step. In the inspection step, the quality of the magnetic recording tape can be confirmed by pre-shipment inspection, for example, for electromagnetic conversion characteristics and traveling durability.

### (4) Configuration Example of a Layer Constituting a Magnetic Recording Tape (Magnetic Recording Tape in which a Magnetic Layer is Formed by Sputtering)

FIG. 9 is a cross-sectional view illustrating a layer structure of a magnetic recording tape T5 according to the present technology. In the magnetic recording tape T5, a reinforcing layer A is disposed on a surface of a base layer 25 on a back layer 26 side out of the two surfaces of the base layer 25. A seed layer 24 is disposed on the other main surface (a surface on the magnetic layer side) of the base layer 25, and a two-layer structure ground layer 23 (23-1 and 23-2) is laminated directly above the single layer seed layer 24.

The tape 5 includes a lubricant layer L, a protective layer P, a magnetic layer 21, an intermediate layer 22, the ground layer 23, the seed layer 24, the base layer 25, the reinforcing layer A, and the back layer 26 in this order from the top. The protective layer P is directly below the lubricant layer L, the magnetic layer 21 is directly below the protective layer P, the intermediate layer 22 is directly below the magnetic layer 21, the ground layer 23 is directly below the intermediate layer 22, the seed layer 24 is directly below the ground layer 23, the base layer 25 is directly below the seed layer 24, the reinforcing layer A is directly below the base layer 25, and the back layer 26 is directly below the reinforcing layer A. The configuration of each of the layers will be described below. Furthermore, in the description of this configuration example, the magnetic layer 21 side of the base layer 25 is defined as an upper side, and the back layer 26 side of the base layer 25 is defined as a lower side.

(4-1) Lubricant Layer

The lubricant layer L illustrated in FIG. 9 is a layer in which a lubricant is blended, and mainly plays a role of reducing friction of the magnetic recording tape T5 during traveling. The lubricant layer L is laminated on the protective layer P.

The lubricant layer L contains at least one lubricant. The lubricant layer L may further contain various additives such as a rust preventive as necessary. The lubricant contains at least one carboxylic acid-based compound having at least two carboxyl groups and one ester bond and represented by the following general chemical formula (1). The lubricant may further contain a lubricant other than the carboxylic acid-based compound represented by the following general chemical formula (1).

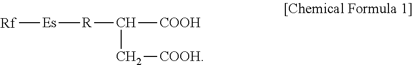

(In the formula, Rf represents an unsubstituted or substituted and saturated or unsaturated fluorine-containing hydrocarbon group or hydrocarbon group, Es represents an ester bond, and R represents an unsaturated or substituted and saturated or unsaturated hydrocarbon group, in which R may be absent.)

The above carboxylic acid-based compound is preferably represented by the following general chemical formula (2) or general chemical formula (3).

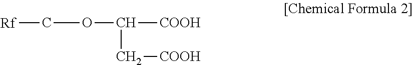

(In the formula, Rf represents an unsubstituted or substituted and saturated or unsaturated fluorine-containing hydrocarbon group or hydrocarbon group.)

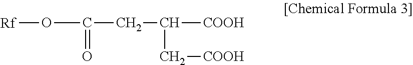

(In the formula, Rf represents an unsubstituted or substituted and saturated or unsaturated fluorine-containing hydrocarbon group or hydrocarbon group.)

The lubricant preferably contains one or both of the carboxylic acid-based compounds represented by the above general chemical formulas (2) and (3).

When a lubricant containing the carboxylic acid-based compound represented by general chemical formula (1) is applied to the magnetic layer 1, the protective layer P, or the like, a lubricating action is exhibited by a cohesive force between the fluorine-containing hydrocarbon groups or hydrocarbon groups Rfs, which are hydrophobic groups. In a case where the Rf group is a fluorine-containing hydrocarbon group, the total carbon number of the compound is preferably 6 to 50, and the total carbon number of the fluorinated hydrocarbon group is preferably 4 to 20. The Rf group may be saturated or unsaturated, and linear, branched, or cyclic, but is particularly preferably saturated and linear.

For example, in a case where the Rf group is a hydrocarbon group, the hydrocarbon group is desirably represented by the following general chemical formula (4).

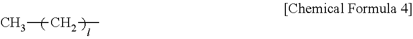

(Provided that in general chemical formula (4), l is an integer selected from a range of 8 to 30, more desirably from a range of 12 to 20.)

Furthermore, in a case where the Rf group is a fluorine-containing hydrocarbon group, the fluorine-containing hydrocarbon group is desirably represented by the following general chemical formula (5).

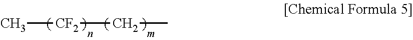

(Provided that in general chemical formula (5), m is an integer selected from a range of 2 to 20, more desirably from a range of 4 to 13, and n is an integer selected from a range of 3 to 18, more desirably from a range of 3 to 10.

The fluorinated hydrocarbon groups may be concentrated in one place as described above, or may be dispersed as illustrated in the following general chemical formula (6), and may be not only —CF₃ and —CF₂— but also —CHF₂, —CHF—, and the like.

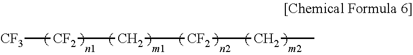

(Provided that in general chemical formula (6), n1+n2=n and m1+m2=m.)

A reason why the number of carbon atoms is limited as described above in general chemical formulas (4), (5), and (6) is as follows. That is, when the number of carbon atoms (l or the sum of m and n) constituting the alkyl group or the fluorine-containing alkyl group is the above lower limit or more, the length of the alkyl group or the fluorine-containing alkyl group is an appropriate length, a cohesive force between the hydrophobic groups is effectively exhibited, a favorable lubricating action is exhibited, and friction/wear durability is improved. Furthermore, when the number of carbon atoms is the above upper limit or less, solubility of the lubricant containing the above carboxylic acid-based compound in a solvent is kept favorable.

In particular, when the Rf group contains a fluorine atom, the Rf group has an effect of reducing a coefficient of friction and moreover, improving traveling performance and the like. However, preferably, a hydrocarbon group is disposed between a fluorine-containing hydrocarbon group and an ester bond to separate the fluorine-containing hydrocarbon group and the ester bond from each other, thus ensuring the stability of the ester bond to prevent hydrolysis. Furthermore, the Rf group may have a fluoroalkyl ether group or a perfluoropolyether group. The R group may be absent. However, in a case where the R group is present, the R group is preferably a hydrocarbon chain having a relatively small number of carbon atoms. Furthermore, the Rf group or the R group may contain an element such as nitrogen, oxygen, sulfur, phosphorus, or halogen as a constituent element, and may further have a hydroxyl group, a carboxyl group, a carbonyl group, an amino group, an ester bond, and the like in addition to the functional groups described above.

Specifically, the carboxylic acid-based compound represented by the above general chemical formula (1) is preferably at least one selected from the compounds illustrated below. That is, the lubricant preferably contains at least one selected from the following compounds.

CF₃(CF₂)₇(CH₂)₁₀COOCH(COOH)CH₂COOH

CF₃(CF₂)₃(CH₂)₁₀COOCH(COOH)CH₂COOH

C₁₇H₃₅COOCH(COOH)CH₂COOH

CF₃(CF₂)₇(CH₂)₂₀COCH₂CH(C₁₈H₃₇)COOCH(COOH)CH₂COOH

CF₃(CF₂)₇COOCH(COOH)CH₂COOH

CHF₂(CF₂)₇COOCH(COOH)CH₂COOH

CF₃(CF₂)₇(CH₂)₂₀COCH₂CH(COOH)CH₂COOH

CF₃(CF₂)₇(CH₂)₆OCOCH₂CH(COOH)CH₂COOH

CF₃(CF₂)₇(CH₂)₁₁OCOCH₂CH(COOH)CH₂COOH

CF₃(CF₂)₃(CH₂)₆OCOCH₂CH(COOH)CH₂COOH

C₁₈H₃₇OCOCH₂CH(COOH)CH₂COOH

CF₃(CF₂)₇(CH₂)₄COOCH(COOH)CH₂COOH

CF₃(CF₂)₃(CH₂)₄COOCH(COOH)CH₂COOH

CF₃(CF₂)₃(CH₂)₇COOCH(COOH)CH₂COOH

CF₃(CF₂)₉(CH₂)₁₀COOCH(COOH)CH₂COOH

CF₃(CF₂)₇(CH₂)₁₂COOCH(COOH)CH₂COOH

CF₃(CF₂)₅(CH₂)₁₀COOCH(COOH)CH₂COOH

CF₃(CF₂)₇CH(C₉H₁₉)CH₂CH═CH(CH₂)₇COOCH(COOH)CH₂COOH

CF₃(CF₂)₇CH(C₆H₁₃)(CH₂)₇COOCH(COOH)CH₂COOH

CH₃(CH₂)₃(CH₂CH₂CH(CH₂CH₂(CF₂)₉CF₃))₂(CH₂)₇COOCH(COOH)CH₂COOH

The carboxylic acid-based compound represented by the above general chemical formula (1) is soluble in a non-fluorine-based solvent having a small impact on environment, and is advantageous because an operation such as application, dipping, or spraying can be performed using a general-purpose solvent such as a hydrocarbon-based solvent, a ketone-based solvent, an alcohol-based solvent, or an ester-based solvent. Specific examples thereof include solvents such as hexane, heptane, octane, decane, dodecane, benzene, toluene, xylene, cyclohexane, methyl ethyl ketone, methyl isobutyl ketone, methanol, ethanol, isopropanol, diethyl ether, tetrahydrofuran, dioxane, and cyclohexanone.

In a case where the protective layer P described below contains a carbon material, when the above carboxylic acid-based compound is applied onto the protective layer P as a lubricant, two carboxyl groups which are polar group portions of a lubricant molecule and at least one ester bond group are adsorbed on the protective layer P, and a lubricant layer L having particularly favorable durability can be formed due to a cohesive force between hydrophobic groups.

Note that the lubricant may be not only held as the lubricant layer L on a surface of the magnetic recording tape T5 as described above, but also contained and held in a layer such as the magnetic layer 21 or the protective layer P constituting the magnetic recording tape T. This is because in a case where the lubricant is applied to the protective layer P, the lubricant can permeate a layer such as the protective layer P. The thickness of the lubricant layer L can be, for example, about 0.1 nm. Note that the lubricant layer may be disposed on a surface of the back layer described below, and can be laminated, for example, on a lower surface of the back layer 26 illustrated in FIGS. 9 and 10.

(4-2) Protective Layer

The protective layer P illustrated in FIG. 9 plays a role of protecting the magnetic layer 21. The protective layer P contains, for example, a carbon material or silicon dioxide (SiO₂). The protective layer P preferably contains a carbon material from a viewpoint of the film strength of the protective layer P. Examples of the carbon material include graphite, diamond-like carbon (abbreviated as DLC), and diamond.

(4-3) Magnetic Layer

The magnetic layer 21 contains magnetic crystal particles, and functions as a layer that records or reproduces a signal using magnetism. In the magnetic layer 21, the magnetic crystal particles are more preferably perpendicularly oriented from a viewpoint of improving recording density and the like. Moreover, the magnetic layer 1 preferably has a granular structure containing a Co-based alloy from this viewpoint.

The magnetic layer 21 having a granular structure contains ferromagnetic crystal particles each containing a Co-based alloy and non-magnetic grain boundaries (non-magnetic material) existing so as to surround the ferromagnetic crystal particles. More specifically, the magnetic layer 21 having a granular structure contains columns (columnar crystals) each containing a Co-based alloy and non-magnetic grain boundaries that surround the columns and physically and magnetically separate the columns from each other. Due to such a granular structure, the magnetic layer 21 exhibits a structure in which columnar magnetic crystal particles are magnetically separated from each other.

The Co-based alloy has a hexagonal close-packed (hcp) structure like Ru in the intermediate layer 22 described later, and its c-axis is oriented in a direction perpendicular to a film surface (magnetic recording tape thickness direction). As described above, since the magnetic layer 21 has the same hexagonal close-packed structure as the intermediate layer 22 directly below the magnetic layer 21, the orientation characteristics of the magnetic layer 21 are further enhanced. As the Co-based alloy, a CoCrPt-based alloy containing at least Co, Cr, and Pt is preferably adopted. The CoCrPt-based alloy is not particularly narrowly limited and may further contain an additive element. Examples of the additive element include one or more elements selected from Ni, Ta, and the like.

The non-magnetic grain boundaries surrounding the ferromagnetic crystal particles contain a non-magnetic metal material. Here, the metal includes a semimetal. As the non-magnetic metal material, for example, at least one selected from a metal oxide and a metal nitride can be adopted, and, a metal oxide is preferably used from a viewpoint of maintaining the granular structure more stably.

Examples of the metal oxide suitable for the non-magnetic grain boundaries include a metal oxide containing at least one element selected from Si, Cr, Cr, Al, Ti, Ta, Zr, Ce, Y, B, and Hf. Specific examples thereof include SiO₂, Cr₂O₃, CuO, Al₂O₃, TiO₂, Ta₂O₅, ZrO₂, B₂O₃, and HfO₂, and a metal oxide containing SiO₂ or TiO₂ is particularly preferable.

Examples of the metal nitride suitable for the non-magnetic grain boundaries include a metal nitride containing at least one element selected from Si, Cr, Co, Al, Ti, Ta, Zr, Ce, Y, and Hf. Specific examples thereof include SiN, TiN, and AlN.

Moreover, the CoCrPt-based alloy contained in the ferromagnetic crystal particles and SiO₂ contained in the non-magnetic grain boundaries preferably have an average atomic number ratio illustrated in the following formula (5). This is because it is possible to achieve a saturation magnetization amount Ms that can suppress an influence of a demagnetizing field and ensure a sufficient reproduction output, thereby further improving the recording/reproducing characteristics.

(CoₓPt_{y}Cr_{100-x-y})_{100-z}—(SiO₂)_{z} (5)

(Provided that in general formula (5), x, v, and z are values within ranges of 69≤x≤72, 10≤y≤16, and 9≤z≤12, respectively.)

The average atomic number ratio can be determined as follows. While ion milling is performed from the protective layer P side of the magnetic recording tape T5 (see FIG. 9, described later), depth direction analysis (depth file measurement) of the magnetic layer 21 is performed by Auger Electron Spectroscopy (hereinafter referred to as “AES”), and the average atomic number ratio among Co, Pt, Cr, Si, and O in a film thickness direction is determined.

A preferable range for the thickness of the magnetic layer 21 is 10 nm to 20 nm. The lower limit thickness 10 nm is a limit thickness from a viewpoint of an influence of thermal disturbance due to reduction of the magnetic particle volume. A thickness exceeding the upper limit thickness 20 nm has a harmful effect from a viewpoint of setting a bit length of a high recording density magnetic recording tape.

The average thickness of the magnetic layer 21 can be determined as follows. First, the magnetic recording tape T is thinly processed perpendicularly to a main surface thereof to manufacture a sample piece. A cross section of the sample piece is observed with a transmission electron microscope (TEM). A device and observation conditions are Device: TEM (H9000NAR manufactured by Hitachi Ltd.), acceleration voltage: 300 kV, and magnification: 100,000 times. Next, using the obtained TEM image, the thickness of the magnetic layer 21 is measured at 10 or more points in a longitudinal direction of the magnetic recording tape T. Thereafter, the measured values are simply averaged (arithmetically averaged) to determine an average thickness of the magnetic layer 21. Note that the measurement points are randomly selected from the test piece.

(4-4) Intermediate Layer

The intermediate layer 22 illustrated in FIG. 9 mainly plays a role of enhancing the orientation characteristics of the magnetic layer 21 formed directly above the intermediate layer 22. The intermediate layer 22 preferably has a crystal structure similar to the main component of the magnetic layer 21 in contact with the intermediate layer 22. For example, in a case where the magnetic layer 21 contains a cobalt (Co)-based alloy, the intermediate layer 22 preferably contains a material having a hexagonal close-packed structure similar to that of the Co-based alloy, and the c-axis of the structure is preferably oriented in a direction perpendicular to a film surface (a thickness direction of the magnetic recording tape). As a result, the crystal orientation characteristics of the magnetic layer 21 can be further enhanced, and matching between the intermediate layer 22 and the magnetic layer 21 in a lattice constant can be relatively favorable.

The material of the hexagonal close-packed structure used in the intermediate layer 22 is preferably ruthenium (Ru) alone or an alloy thereof. Examples of the Ru alloy include a Ru alloy oxide such as Ru—SiO₂, RuTiO₂, or Ru—ZrO₂. However, the Ru material is a rare metal, and the intermediate layer 22 is preferably as thin as possible, preferably 6.0 nm or less, more preferably 5.0 nm or less, and still more preferably 2.0 nm or less from a viewpoint of cost Alternatively, a layer structure not including the intermediate layer 22 may be adopted from the same viewpoint of cost. Since the ground layer 23 and the seed layer 24 described later are disposed on the base layer 25, in a case where the thickness of the intermediate layer 22 is reduced, or in a case where a layer structure not including the intermediate layer 2 is adopted, a magnetic recording tape with a favorable SNR can be obtained. For example, the magnetic recording tape having a layer structure not including the intermediate layer 2 may have a layer structure in which the lubricant layer L, the protective layer P, the magnetic layer 21, the ground layer 23, the seed layer 24, the base layer 25, the reinforcing layer A, and the back layer 26 illustrated in FIG. 9 are laminated in this order, or may have a layer structure in which the lubricant layer L, the protective layer P, the magnetic layer 21, the ground layer 23, the seed layer 24, the reinforcing layer A, the base layer 25, and the back layer 26 illustrated in FIG. 10 are laminated in this order.

Note that by utilizing “wettability” of the intermediate layer 22, when a material contained in the magnetic layer 21 formed on the intermediate layer 22 by vacuum film formation is crystallized, the material is easily diffused, and the column size of the crystal can be increased. For example, in order for the intermediate layer 22 containing Ru to exhibit wettability, the intermediate layer 22 requires a thickness of 0.5 nm or more.

(4-5) Ground Layer

In the tape T5 illustrated in FIG. 9, the ground layer 23 is disposed directly below the intermediate layer 22. More specifically, the upper ground layer 23-1 is disposed below the intermediate layer 22, and a lower ground layer 23-2 is disposed directly below the upper ground layer 23-1. That is, the ground layer 23 has a two-layer structure including the upper ground layer 23-1 and the lower ground layer 23-2.

Each of the upper ground layer 23-1 and the lower ground layer 23-2 constituting the ground layer 23 preferably contains a Co-based alloy similar to the Co-based alloy contained in the magnetic layer 21. A reason is for this is as follows. That is, when a Co-based alloy is used for the ground layer 23, the ground layer 23 has a crystal structure having the same hexagonal close-packed (hcp) structure as the magnetic layer 21 or the intermediate layer 22 described above, and its c-axis is oriented in a direction perpendicular to a film surface (a thickness direction of the magnetic recording tape). As described above, since the ground layer 23 has the same hexagonal close-packed structure as the magnetic layer 21 or the intermediate layer 22, the orientation characteristics of the magnetic layer 21 can be further enhanced.

Here, the upper ground layer 23-1 constituting the ground layer 23 preferably has an average atomic number ratio represented by the following formula (6).

Co_{(100-y)}Cr_{y} (6)

(Provided that y is a value within a range of 37≤y≤45.)

In a case where y is a value within a range of 0≤y≤36, the CoCr film is in an hcp phase, and in a case where y is a value within a range of 54≤y≤66, the CoCr film is in a σ phase. In a case where the CoCr film is in a coexistence state of the hcp phase and the σ phase, a metal film having a hexagonal close-packed structure that grows on the CoCr film has a favorable perpendicular c-axis orientation and an isolated column shape. A case where y is less than 37 is unsuitable because the CoCr film is only in the hcp phase, and therefore isolation of a column of the metal film growing on the CoCr film is reduced. Meanwhile, a case where y exceeds 45 is unsuitable because the c-axis orientation of the metal film growing on the CoCr film is reduced by an increase in the ratio of the σ phase in the CoCr film.

The upper ground layer 23-1 may contain silicon dioxide within a range illustrated in the average atomic number ratio represented by the following formula (7).

[Co_{(100-y)}Cr_{y}]_{(100-z)}(SiO₂)_{z} (7)

(Provided that z is a value within a range of z≤30.)

In the above formula (7), a case where z exceeds 30 is not preferable because the amounts of the magnetic columnar crystals (columns) of the Co-based alloy and the non-magnetic grain boundaries that surround the columns and physically and magnetically separate the columns from each other are excessive, and a structure in which the columnar magnetic crystal particles are magnetically excessively separated from each other is exhibited. Note that in formula (7), in a case where Z=0, formula (6) is applied.

The thickness of the upper ground layer 23-1 is preferably within a range of 20 to 50 nm. In a case where the thickness of the upper ground layer 23-1 is less than 20 nm, it is difficult to form a mountain shape at a top of a column, which is the key to the granular shape, and sufficient granularity of the intermediate layer growing on the upper ground layer 23-1 cannot be ensured. Furthermore, in a case where the thickness of the upper ground layer 23-1 exceeds 50 nm, the column size of the intermediate layer increases due to coarsening of the column. Therefore, the column size of the magnetic layer finally increases, and noise of the recording/reproducing characteristics increases.

Next, the lower ground layer 23-2 disposed directly below the upper ground layer 23-1 also preferably has a composition containing at least Co and Cr, and has the same average atomic number ratio as that in the above formula (6) or (7). A preferable range of the thickness of the lower ground layer 23-2 is similar to that of the upper ground layer 23-1.

A case where the upper ground layer 23-1 and the lower ground layer 23-2 are disposed in the ground layer 23 to form a two-layer structure is preferable because crystal orientation and granularity can be achieved at the same time by setting a film forming condition for enhancing crystal orientation for the lower ground layer 23-2, and setting a film forming condition having high granularity for the upper ground layer 23-1.

The ground layer 23 may include only the upper ground layer 23-1. In this case, the seed layer 24 described below may include only a lower seed layer.

(4-6) Seed Layer

The seed layer 24 illustrated in FIG. 9 is located below the ground layer 23 and formed directly above one main surface of the base layer 25 (described later). The seed layer 24 is required for ensuring a favorable signal-to-noise ratio (SNR) even in a case where the intermediate layer 22 described later is formed thinly or even in a case where the intermediate layer 22 is not disposed. Furthermore, the seed layer 24 also plays a role of bringing the base layer 25 into close contact with the upper layers equal to or higher than the ground layer 23, that is, the ground layer 23 (23-1 and 23-2), the intermediate layer 22, and the magnetic layer 21.

The seed layer 24 preferably contains at least two atoms of titanium (Ti) and oxygen (O), and preferably has an average atomic number ratio represented by the following formula (8).

Ti₍₁₀₀₋ₓ₎Oₓ (8)

(Provided that X≤10 is satisfied.)

Alternatively, the seed layer 4 preferably contains three atoms of Ti, Cr, and O, and preferably has an average atomic number ratio represented by the following formula (9). A case where the seed layer 4 contains Cr is preferable because matching with the ground layer 23 (upper ground layer 23-1 and lower ground layer 23-2) and the magnetic layer 21 each similarly containing Cr is improved.

(TiCr)₍₁₀₀₋ₓ₎Oₓ (9)

(Provided that X≤10 is satisfied.)

Average atomic number ratios represented by the above formulas (8) and (9) are not preferable because when X exceeds 10 in each of the formulas, a TiO₂ crystal is formed in the seed layer, and a function as an amorphous film is significantly reduced.

Since Ti contained in the seed layer 24 has a hexagonal close-packed structure like the Co-based alloy, matching with the magnetic layer 21, the intermediate layer 22, and the ground layer 23 is favorable.

The seed layer 24 contains oxygen. This is because oxygen derived from or caused by a film constituting the base layer 25 described later enters the seed layer 24. In this regard, the seed layer 24 has a different atomic structure from a seed layer of a hard disk (HDD) that does not use the base layer 25 constituted by a film. Note that the total thickness of the seed layer 24 is preferably 5 nm or more and 30 nm or less.

The seed layer 24 may have a two-layer structure. For example, a layer (upper seed layer) in contact with the ground layer 23 can contain nickel tungsten (Ni₉₆W₆). A layer (lower seed layer) in contact with the base layer 25 (or the reinforcing layer A in FIG. 10) may contain at least Ti, Cr, and O, and may have a composition of an average atomic number ratio represented by the above formula (9).

The thickness of the upper seed 41 may be, for example, within a range of 5 nm or more and 30 nm or less, and the thickness of the lower ground layer 42 may be within a range of, for example, 2 nm or more and 30 nm or less.

(4-7) Base Layer

The base layer 25 illustrated in FIG. 9 is a long flexible non-magnetic support, and mainly functions as a base layer of the magnetic recording tape. The base layer 5 is also referred to as a base film layer or a substrate, and is a film layer that imparts appropriate rigidity to the entire magnetic recording tape T5.

The description for the base layer 3 in the above “(2-3) Base layer” (for example, the description regarding the average thickness and the material) also applies to the base layer 25. Therefore, description for the base layer 25 will be omitted.

(4-8) Reinforcing Layer

The reinforcing layer A illustrated in FIG. 9 is disposed on a surface of the base layer 25 on the back layer 26 side out of the two surfaces of the base layer 25, and contains a metal or a metal oxide. Alternatively, as illustrated in FIG. 10, the reinforcing layer A may be disposed on a surface of the base layer 25 on the magnetic layer 21 side out of the two surfaces of the base layer 25.

According to one preferable embodiment of the present technology, the tape T5 has a configuration in which a black area in an image obtained by binarizing an optical microscope image of a rectangular region of 64 μm×48 μm of the reinforcing layer A is 300 μm² or less. The configuration brings about a particularly excellent effect of improving transversal dimensional stability. The black area can be more preferably 280 μm² or less, still more preferably 260 μm² or less, and further still more preferably 240 μm² or less. The black area is preferably smaller, and the black area can be, for example, 0 μm² or more.

According to another preferable embodiment of the present technology, the tape T5 can have a configuration in which the number of black regions in an image obtained by binarizing an optical microscope image of a rectangular region of 64 μm×48 μm of the reinforcing layer A is 100 or less. The number of black regions can be more preferably 80 or less, still more preferably 60 or less, and further still more preferably 50 or less. The number of black regions is preferably smaller, and the number of black regions can be, for example, 0 or more.

According to a particularly preferable embodiment of the present technology, the tape T5 can have a configuration in which a black area in an image obtained by binarizing an optical microscope image of a rectangular region of 64 μm×48 μm of the reinforcing layer A is 300 μm² or less, and the number of black regions in the image is 100 or less.

The black area and the number of black regions may be measured by a similar method to the measurement method described in the above “(2-4) Reinforcing layer”.

As illustrated in FIG. 9, the reinforcing layer A may be disposed on a surface of the base layer 23 on the back layer 26 side. Alternatively, the reinforcing layer A may be disposed on a surface of the base layer 23 on the magnetic layer 21 side, as in a tape T6 illustrated in FIG. 10. By laminating the reinforcing layer A on either surface or both surfaces of the base layer 25, the tape T5 is reinforced.

With the reinforcing layer A, the effects described in the above “(2-4) Reinforcing layer” are exhibited.

The Young's modulus of the reinforcing layer A may also be as described in the above “(2-4) Reinforcing layer”. As described in the above “(2-4) Reinforcing layer”, the Young's modulus may also be measured using a laminate including only the base layer 23 and the reinforcing layer A.

The tape T5 can also have the same total TDS as that in the above “(2-4) Reinforcing layer”.

The thickness of the reinforcing layer A may also be the same as that described in the above “(2-4) Reinforcing layer”.

According to one preferable embodiment of the present technology, as described in the above “(2-4-1) Reinforcing layer constituted by a vapor-deposited film layer”, the reinforcing layer A may be a vapor-deposited film layer containing a metal or a metal oxide.

According to another preferable embodiment of the present technology, as described in the above (2-4-2) Reinforcing layer constituted by a vapor-deposited film layer and a metal sputter layer, the reinforcing layer A may be constituted by a vapor-deposited film layer containing a metal or a metal oxide and a metal sputter layer, and the metal sputter layer may be disposed between the base layer and the vapor-deposited film layer.

The vapor-deposited film layer and the metal sputter layer are as described in the above “(2-4-1) Reinforcing layer constituted by a vapor-deposited film layer” and (2-4-2) Reinforcing layer constituted by a vapor-deposited film layer and a metal sputter layer, and therefore description thereof will be omitted.

(4-9) Back Layer

The back layer 26 illustrated in FIG. 9 is formed on a lower main surface of the base layer 25. The description for the back layer 4 in the above “(2-5) Back layer” also applies to the back layer 26. Therefore, description for the back layer 26 will be omitted.

(4-10) Soft Magnetic Underlayer

The magnetic recording tape according to the present technology may further include a soft magnetic underlayer (abbreviated as SUL).

For example, in the case of the layer structure illustrated in FIG. 9, the soft magnetic underlayer can be disposed between the seed layer 24 and the base layer 25. That is, in a case where the soft magnetic underlayer is included in the layer structure illustrated in FIG. 9, the seed layer 24, the soft magnetic underlayer, the base layer 25, and the reinforcing layer A are laminated in this order.

Furthermore, for example, in the case of the layer structure illustrated in FIG. 10, the soft magnetic underlayer can be disposed between the seed layer 24 and the reinforcing layer A. That is, in a case where the soft magnetic underlayer is included in the layer structure illustrated in FIG. 10, the seed layer 24, the soft magnetic underlayer, the reinforcing layer A, and the base layer 25 are laminated in this order.

The soft magnetic underlayer is disposed in order to efficiently draw a leakage flux generated from a perpendicular magnetic head into the magnetic layer 21 when magnetic recording is performed on the magnetic layer 21. By disposing the soft magnetic underlayer, the magnetic field strength from the magnetic head can be increased, and magnetic recording can be performed at a higher density. Note that the magnetic recording tape including the soft magnetic underlayer can be referred to as a “two-layer perpendicular magnetic recording tape”.

The soft magnetic underlayer contains an amorphous soft magnetic material. The soft magnetic underlayer may contain, for example, a Co-based material, and more specifically, for example, a CoZrNb alloy, CoZrTa, or CoZrTaNb. Alternatively, the soft magnetic underlayer may contain a Fe-based material, more specifically, for example, FeCoB, FeCoZr, or FeCoTa.

The soft magnetic underlayer may be, for example, a single layer, and more specifically, a single layer containing any of the above materials.

Alternatively, the soft magnetic underlayer may contain a plurality of layers, and may have, for example, a three-layer structure in which a thin intervening layer is sandwiched between two soft magnetic layers. In this case, the soft magnetic underlayer may be configured as an antiparallel coupled SUL (APC-SUL) having a structure in which magnetization is positively antiparallel utilizing an exchange bond via the intervening layer.

### (5) Example of a Method for Manufacturing a Magnetic Recording Tape According to the Present Technology (Magnetic Recording Tape in which a Magnetic Layer is Formed by Sputtering)

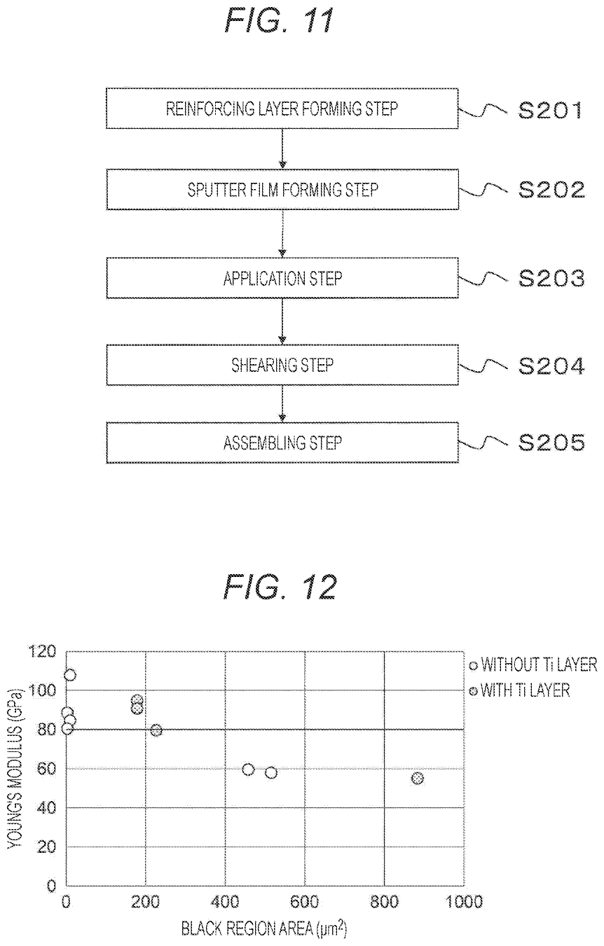

A method for manufacturing the tape T5 described in the above “(4) Configuration example of a layer constituting a magnetic recording tape (magnetic recording tape in which a magnetic layer is formed by sputtering)” will be described below with reference to FIG. 11.

In step S201, the reinforcing layer A is formed on the substrate forming the base layer 25 to obtain a laminate including the base layer 25 and the reinforcing layer A. Since step S201 is the same as step S102, description thereof will be omitted.

In step S202, the seed layer 24, the ground layer 23, the intermediate layer 22, and the magnetic layer 21 are sputter-deposited in this order on one main surface of the laminate (step S202: sputter film forming step). An atmosphere in a film forming chamber during sputtering is set to, for example, about 1×10⁻⁵ Pa to 5×10⁻⁵ Pa. The thicknesses and characteristics (for example, magnetic characteristics) of the seed layer 24, the ground layer 23, the intermediate layer 22, and the magnetic layer 21 can be controlled by adjusting a tape line speed for winding the laminate, pressure of argon (Ar) gas or the like introduced during sputtering (sputter gas pressure), input power, and the like. Examples of conditions for forming these four layers will be described below.

(Conditions for Forming a Seed Layer)

Under the following film forming conditions, a seed layer containing Ti₍₁₀₀₋ₓ₎Oₓ (in which x=2) is sputter-deposited on a surface of a long polymer film forming the base layer 25 so as to have a thickness of 10 nm.

Film forming method: DC magnetron sputtering method

Target: Ti target

Gas species: Ar

Gas pressure: 0.25 Pa

Input power: 0.1 W/mm²

(Conditions for Forming a Lower Ground Layer)

Under the following film forming conditions, a lower ground layer containing Co_{(100-y)}Cr_{y} (in which y=40) is sputter-deposited on the seed layer so as to have a thickness of 30 nm.

Film forming method: DC magnetron sputtering method

Target: CoCr target

Gas species: Ar

Gas pressure: 0.2 Pa

Input power: 0.13 W/mm²

Mask: None

(Conditions for Forming an Upper Ground Layer)

Under the following film forming conditions, an upper ground layer containing Co_{(100-y)}Cry_{(100-z)}(SiO₂)_{z} (in which y=40 and z=0) was sputter-deposited on the lower ground layer so as to have a thickness of 30 nm.

Target: CoCrSiO2 target

Gas species: Ar

Gas pressure: 6 Pa

Input power: 0.13 W/mm²

Mask: None

(Conditions for Forming an Intermediate Layer)

Under the following film forming conditions, an intermediate layer containing Ru is sputter-deposited on the ground layer so as to have a thickness of 2 nm.

Film forming method: DC magnetron sputtering method

Target: Ru target

Gas species: Ar

Gas pressure: 0.5 Pa

(Conditions for Forming a Magnetic Layer)

Under the following film forming conditions, a magnetic layer containing (CoCrPt)—(SiO₂) is formed on the intermediate layer so as to have a thickness of 14 nm.

Film forming method: DC magnetron sputtering method

Target: (CoCrPt)—(SiO₂) target

Gas species: Ar

Gas pressure: 1.5 Pa

In a case where the intermediate layer 22 is not disposed, the intermediate layer 22 is not formed, and the magnetic layer 21 is formed directly above the ground layer 23. In a case where the seed layer 24 has a two-layer structure of a lower seed layer and an upper seed layer, these two layers are formed in order. In a case where the ground layer 3 includes a lower ground layer and an upper ground layer, these two layers are formed in this order.

In step S202, the protective layer P is further formed on the oriented magnetic layer 21. As a method for forming the protective layer P, for example, a chemical vapor deposition (abbreviated as CVD) method or a physical vapor depositin (abbreviated as PVD) method can be used. Examples of conditions for forming the protective layer are as follows.

(Conditions for Forming a Protective Layer)

Under the following film forming conditions, a protective layer containing carbon is sputter-deposited on the magnetic layer 21 so as to have a thickness of 5 nm.

Film forming method: DC magnetron sputtering method

Target: carbon target

Gas species: Ar

Gas pressure: 1.0 Pa

In step S203, a coating material for forming the back layer 26 is applied onto the other main surface of the base layer 26 and dried to form the back layer 26. The coating material may be prepared in advance by kneading and/or dispersing a binder, inorganic particles, a lubricant, and the like in a solvent. For example, a back layer containing non-magnetic powder containing carbon and calcium carbonate and a polyurethane-based binder is formed so as to have a thickness of 0.3 μm.

Next, a lubricant is applied onto the protective layer P that has already been formed to form a lubricant layer L. As a method for applying the lubricant, for example, various application methods such as gravure coating and dip coating can be adopted, and the method for applying the lubricant is not particularly limited. For example, a lubricant coating material is manufactured by mixing 0.11% by mass of a carboxylic acid perfluoroalkyl ester and 0.06% by mass of a fluoroalkyldicarboxylic acid derivative with a general-purpose solvent.

The magnetic recording tape T5 can be manufactured by the manufacturing method described above.

Note that in order to adjust warpage of the manufactured magnetic recording tape in a tape width direction, a hot roll treatment for causing the magnetic recording tape to travel while a raw fabric roll is in contact with a metal roll heated so as to have a surface temperature of about 150° C. to 230° C. may be performed on the magnetic recording tape.

In step S204, the wide magnetic recording tape T5 obtained as described above is sheared into, for example, a magnetic recording tape width conforming to the standard of the product type of the magnetic recording tape (shearing step). For example, the magnetic recording tape T5 is sheared into a width of ½ inches (12.65 mm) and wound around a predetermined roll. As a result, the long magnetic recording tape having a desired magnetic recording tape width can be obtained. In this shearing step, a necessary inspection may be performed.

In step S205, next, the magnetic recording tape sheared into a predetermined width is cut into a predetermined length according to the product type to be formed into a form of a cartridge tape 5 as illustrated in FIG. 7. Specifically, the magnetic recording tape T5 having a predetermined length is wound around a reel 52 disposed in a cartridge case 51 and housed therein.

The cartridge tape 5 can be packed and shipped, for example, through a final product inspection step. In the inspection step, the quality of the magnetic recording tape can be confirmed by pre-shipment inspection, for example, for electromagnetic conversion characteristics and traveling durability.

### 2. Second Embodiment of the Present Technology (Magnetic Recording Tape Cartridge)

The present technology also provides a magnetic recording tape cartridge including the magnetic recording tape described in the above “1. First embodiment of the present technology (magnetic recording tape)”, in which the magnetic recording tape is housed in a case while being wound around a reel. An example of the configuration of the magnetic recording tape cartridge may be as described above.

The magnetic recording tape housed in the cartridge has excellent transversal dimensional stability as described above. Moreover, a dimensional change of the magnetic recording tape can be suppressed or prevented, and the thickness of the tape can be reduced. Moreover, the length of the tape housed in one magnetic recording tape cartridge can be increased. Therefore, a recording capacity per magnetic recording tape cartridge can be increased.

### EXAMPLES

Magnetic recording tapes each including a reinforcing layer (reference numeral A in FIG. 1) were manufactured (Examples 1 to 7 and Comparative Examples 1 to 3 in Table 1 below). The reinforcing layers of these magnetic recording tapes were formed using the vacuum film forming device described with reference to FIG. 8 in the above “(3-2) Reinforcing layer forming step”. For each of these magnetic recording tapes, a film containing PEN and having a thickness of 3.2 μm was used as a substrate for forming a base layer. For each of these magnetic recording tapes, a magnetic layer, a non-magnetic layer, and a back layer were manufactured using the compositions described in the above “(3-1) Coating material preparing step”. Each of these layers was formed by application by applying a coating material, and had the layer structure illustrated in FIG. 1.

The reinforcing layer of each of the magnetic recording tapes of Examples 1 to 4 and Comparative Examples 1 and 2 is constituted only by a Co vapor-deposited film layer.

The reinforcing layer of each of the magnetic recording tapes of Examples 5 to 7 and Comparative Example 3 is constituted by a metal (Ti) sputter layer and a Co vapor-deposited film layer.

The vapor-deposited film layer was formed in a vapor-deposited film layer forming area 110. A metal material (Co) in a crucible was irradiated with an electron beam accelerated and emitted from an electron beam generation source to heat and evaporate Co. The heated and evaporated Co was vapor-deposited on a film traveling along a cooling can to form a vapor-deposited film layer. Vapor deposition is performed from the position of a maximum incident angle θ₁ to the position of a minimum incident angle θ₂ illustrated in FIG. 8. By adjusting the maximum incident angle and the minimum incident angle, the thickness of the vapor-deposited film layer was controlled. The maximum incident angle is formed by a line connecting the center of the cooling can and the vapor deposition start point and a line connecting the vapor deposition start point and the vapor deposition source. The minimum incident angle is formed by a line connecting the center of the cooling can and the vapor deposition end point and a line connecting the vapor deposition end point and the vapor deposition source.

The metal sputter layer was formed in a metal sputter layer forming area 120. In the metal sputter layer forming area 120, there was a sputter cathode in which a Ti target is disposed, and a Ti sputter layer was thereby formed.

For each of the manufactured magnetic recording tapes, the black area and the number of black regions described above were measured by the measuring method described above. Furthermore, the Young's modulus of the reinforcing layer of each of the manufactured magnetic recording tapes in a tape longitudinal direction was also measured by the measuring method described above.

Measurement results are illustrated in Table 1 below. Furthermore, the thickness of the reinforcing layer and the thickness of the metal sputter layer are also illustrated in Table 1 below.

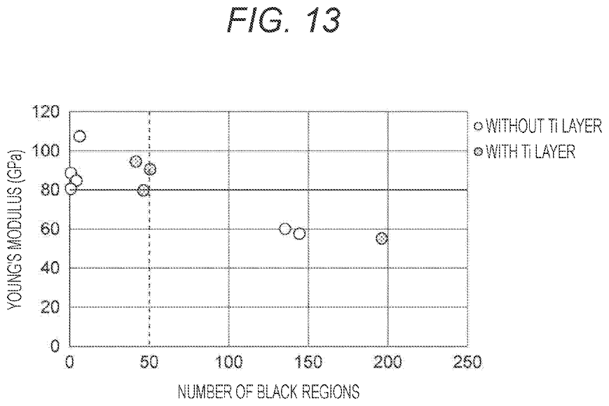

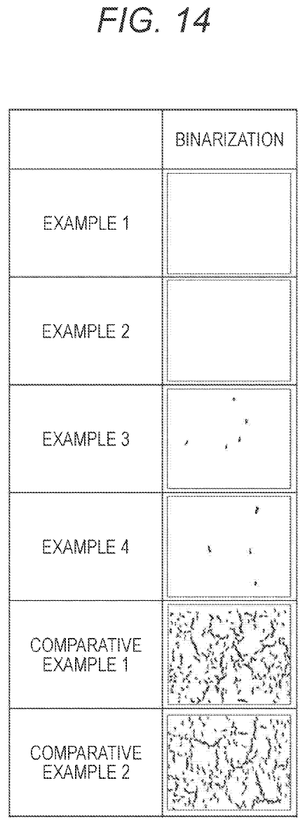

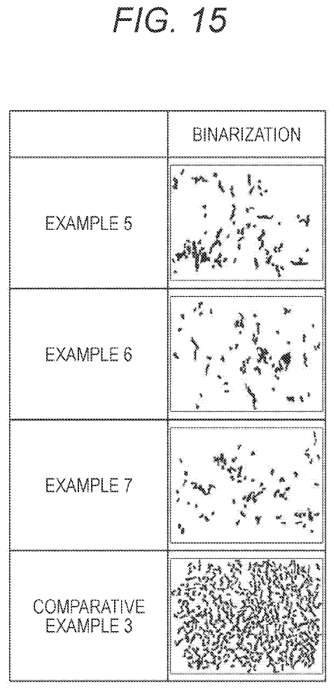

FIG. 12 illustrates a relationship between a Young's modulus and a black area. FIG. 13 illustrates a relationship between a Young's modulus and the number of black regions. Moreover, FIGS. 14 and 15 illustrate images of the magnetic recording tapes of Examples after binarization.

TABLE 1

| | | | Thickness | | | | | | |
|---|---|---|---|---|---|---|---|---|---|
| | | | of vapor- | | | | | Number of | Young's |
| | Minimum | Maximum | deposited | | Material of | Thickness | | black | modulus of |
| | incident | incident | film layer | Sputter | sputter | of sputter | Black area | regions | reinforcing |
| | angle (°) | angle (°) | (nm) | layer | layer | layer (nm) | (μm²) | (number) | layer (GPa) |
| Example 1 | 0 | 90 | 256 | Absent | — | — | 0 | 0 | 89 |
| Example 2 | 0 | 90 | 267 | Absent | — | — | 3 | 0 | 81 |
| Example 3 | 0 | 90 | 285 | Absent | — | — | 8 | 5 | 108 |
| Example 4 | 0 | 90 | 341 | Absent | — | — | 9 | 3 | 85 |
| Comparative | 10.5 | 20 | 377 | Absent | — | — | 514 | 144 | 58 |
| Example 1 | | | | | | | | | |
| Comparative | 30 | 60 | 377 | Absent | — | — | 459 | 135 | 60 |
| Example 2 | | | | | | | | | |
| Example 5 | 13.5 | 17 | 151 | Present | Ti | 2 | 227 | 46 | 80 |
| Example 6 | 13.5 | 17 | 152 | Present | Ti | 4 | 178 | 41 | 95 |
| Example 7 | 13.5 | 17 | 153 | Present | Ti | 10 | 177 | 50 | 91 |
| Comparative | 13.5 | 17 | 150 | Absent | — | — | 885 | 196 | 55 |
| Example 3 | | | | | | | | | |

The above results indicate that each of the magnetic recording tapes of Examples 1 to 7 had a higher Young's modulus than each of the magnetic recording tapes of Comparative Examples 1 to 3. The Young's modulus of each of the reinforcing layers of the magnetic recording tapes of Examples 1 to 7 in the longitudinal direction was 80 GPa or more.

Furthermore, the above results indicate that the smaller the black area, the higher the Young's modulus in the longitudinal direction. For example, in a case where the black area is 300 μm² or less, particularly in a case where the black area is 240 μm² or less, it is indicated that the Young's modulus in the longitudinal direction is 80 GPa or more. Furthermore, it is indicated that the smaller the black area, the higher the Young's modulus in the longitudinal direction. For example, in a case where the number of black regions is 70 or less, particularly in a case where the number of black regions is 50 or less, it is indicated that the Young's modulus in the longitudinal direction is 80 GPa or more.

As described in the above “(2-4) Reinforcing layer”, there is a correlation between the Young's modulus and the total TDS, and the higher the Young's modulus, the lower the TDS. For example, the total TDS of the magnetic recording tape including the PEN base layer having a thickness of 3.2 μm used in the present Examples is preferably 350 ppm or less, and the Young's modulus of the reinforcing layer is preferably 80 GPa or more in order to set the total TDS to 350 ppm or less. As described above, since the Young's modulus of each of the reinforcing layers of the magnetic recording tapes of Examples 1 to 7 in the longitudinal direction is 80 GPa or more, the total TDS of the magnetic recording tape including the PEN base layer having a thickness of 3.2 μm can be set to 350 ppm or less. By laminating the reinforcing layer according to the present technology on a base layer having another thickness or a base layer containing another material, a magnetic recording tape having a lower total TDS can also be obtained.

These results indicate that the magnetic recording tape according to the present technology has particularly excellent transversal dimensional stability because of having a high Young's modulus in the longitudinal direction. The magnetic recording tape according to the present technology can suppress or prevent a dimensional change of the tape, for example, even in a case where a tension is applied while the tape is traveling, or even in a case where there is a change, for example, in temperature and/or humidity.

Note that the present technology can have the following configurations.

[1] A magnetic recording tape having a layer structure including a magnetic layer, a base layer, and a back layer in this order, in which

a reinforcing layer containing a metal or a metal oxide is disposed on either a surface of the base layer on the magnetic layer side or a surface of the base layer on the back layer side, and

a black area in an image obtained by binarizing an optical microscope image of a rectangular region of 64 μm×48 μm of the reinforcing layer is 300 μm² or less.

[2] The magnetic recording tape according to [1], in which the reinforcing layer has a thickness of 500 nm or less.

[3] The magnetic recording tape according to [1] or [2], in which the reinforcing layer has a Young's modulus of 70 GPa or more.

[4] The magnetic recording tape according to any one of [1] to [3], in which the Young's modulus of the reinforcing layer is 10 times or more the Young's modulus of the base layer.

[5] The magnetic recording tape according to any one of [1] to [4], in which the reinforcing layer is a vapor-deposited film layer containing a metal or a metal oxide.

[6] The magnetic recording tape according to [5], in which the vapor-deposited film layer has a thickness of 350 nm or less.

[7] The magnetic recording tape according to any one of [1] to [6], in which

the reinforcing layer is constituted by a vapor-deposited film layer containing a metal or a metal oxide and a metal sputter layer, and

the metal sputter layer is disposed between the base layer and the vapor-deposited film layer.

[8] The magnetic recording tape according to [7], in which the metal sputter layer has a thickness of 25 nm or less.

[9] The magnetic recording tape according to [7] or [8], in which the vapor-deposited film layer has a thickness of 10 nm to 200 nm.

[10] A magnetic recording tape having a layer structure including a magnetic layer, a base layer, and a back layer in this order, in which

a reinforcing layer containing a metal or a metal oxide is disposed on either a surface of the base layer on the magnetic layer side or a surface of the base layer on the back layer side, and

the number of black regions in an image obtained by binarizing an optical microscope image of a rectangular region of 64 μm×48 μm of the reinforcing layer is 70 or less.

[11] The magnetic recording tape according to any one of [1] to [9], in which the magnetic layer has a track density of 10000 tracks/inch or more in a tape width direction.

[12] The magnetic recording tape according to any one of [1] to [9] and [11], in which the base layer has a thickness of 3.6 μm or less.

[13] The magnetic recording tape according to [5], in which the vapor-deposited film layer is formed by an electron beam vapor deposition method.

[14] The magnetic recording tape according to any one of [1] to [9] and [11], in which the magnetic recording tape has a total thickness of 5.6 μm or less.

[15] A magnetic recording tape cartridge including the magnetic recording tape according to [1], in which the magnetic recording tape is housed in a case while being wound around a reel.

### REFERENCE SIGNS LIST

T1 Magnetic recording tape
1 Magnetic layer
2 Non-magnetic layer
3 Base layer
A Reinforcing layer
4 Back layer

1. A magnetic recording tape having a layer structure including a magnetic layer, a base layer, and a back layer in this order, wherein
a reinforcing layer containing a metal or a metal oxide is disposed on either a surface of the base layer on the magnetic layer side or a surface of the base layer on the back layer side, and
a black area in an image obtained by binarizing an optical microscope image of a rectangular region of 64 μm×48 μm of the reinforcing layer is 300 μm² or less.

2. The magnetic recording tape according to claim 1, wherein the reinforcing layer has a thickness of 500 nm or less.

3. The magnetic recording tape according to claim 1, wherein the reinforcing layer has a Young's modulus of 70 GPa or more.

4. The magnetic recording tape according to claim 1, wherein the Young's modulus of the reinforcing layer is 10 times or more the Young's modulus of the base layer.

5. The magnetic recording tape according to claim 1, wherein the reinforcing layer is a vapor-deposited film layer containing a metal or a metal oxide.

6. The magnetic recording tape according to claim 5, wherein the vapor-deposited film layer has a thickness of 350 nm or less.

7. The magnetic recording tape according to claim 1, wherein
the reinforcing layer is constituted by a vapor-deposited film layer containing a metal or a metal oxide and a metal sputter layer, and
the metal sputter layer is disposed between the base layer and the vapor-deposited film layer.

8. The magnetic recording tape according to claim 7, wherein the metal sputter layer has a thickness of 25 nm or less.

9. The magnetic recording tape according to claim 7, wherein the vapor-deposited film layer has a thickness of 10 nm to 200 nm.

10. A magnetic recording tape having a layer structure including a magnetic layer, a base layer, and a back layer in this order, wherein
a reinforcing layer containing a metal or a metal oxide is disposed on either a surface of the base layer on the magnetic layer side or a surface of the base layer on the back layer side, and
the number of black regions in an image obtained by binarizing an optical microscope image of a rectangular region of 64 μm×48 μm of the reinforcing layer is 70 or less.

11. The magnetic recording tape according to claim 1, wherein the magnetic layer has a track density of 10000 tracks/inch or more in a tape width direction.

12. The magnetic recording tape according to claim 1, wherein the base layer has a thickness of 3.6 μm or less.

13. The magnetic recording tape according to claim 5, wherein the vapor-deposited film layer is formed by an electron beam vapor deposition method.

14. The magnetic recording tape according to claim 1, wherein the magnetic recording tape has a total thickness of 5.6 μm or less.

15. A magnetic recording tape cartridge comprising the magnetic recording tape according to claim 1, wherein the magnetic recording tape is housed in a case while being wound around a reel.
